(19) United States
(12) Patent Application Publication
(10) Pub. No.: US 2025/0175925 A1
(43) Pub. Date: May 29, 2025

(54) METHOD AND APPARATUS FOR SESSION MANAGEMENT

(71) Applicant: Telefonaktiebolaget LM Ericsson (publ), Stockholm (SE)

(72) Inventors: Yunjie Lu, Shanghai (CN); Juying Gan, Shanghai (CN); Xiao Li, Shanghai (CN); Gang Ren, Shanghai (CN); Beibei Li, Shanghai (CN); Fushan Zheng, Shanghai (CN); Song Wang, Shanghai (CN)

(21) Appl. No.: 18/725,737

(22) PCT Filed: Dec. 29, 2022
(86) PCT No.: PCT/CN2022/143385

§ 371 Date: Jun. 28, 2024

(30) Foreign Application Priority Data
Dec. 31, 2021 (WO) PCT/CN2021/143791

(51) Int. Cl. H04W 60/06; H04W 76/30

(52) U.S. Cl. CPC H04W 60/06; H04W 76/30

(57) ABSTRACT

Embodiments of the present disclosure provide method and apparatus for session management. A method performed by a first session management node comprises receiving a deregistration notification of a protocol data unit (PDU) session of a user equipment from a data management node. The deregistration notification comprises a deregistration reason indicating duplicated PDU session. The method further comprises releasing at least one resource corresponding to the PDU session.

### TECHNICAL FIELD

The non-limiting and exemplary embodiments of the present disclosure generally relate to the technical field of communications, and specifically to methods and apparatuses for session management.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example fifth generation (5G) System (5GS) as defined by 3rd Generation Partnership Project (3GPP), a protocol data unit (PDU) Session establishment may correspond to a user equipment (UE) initiated PDU session establishment procedure, or a UE initiated PDU session handover between 3GPP and non-3GPP, or a UE initiated PDU session handover from EPS to 5GS, or a Network triggered PDU session establishment procedure.

For example, when an Access and Mobility Management Function (AMF) receives a request from UE to establish a new PDU session, the AMF selects an session management function (SMF) for example according to UE location, Data Network Name (DNN), slice, etc. and creates session management (SM) context in the selected SMF. The UE assigns a PDU session identifier (ID) used by the Radio Access Network (RAN) and Core Network to uniquely identify a PDU session for the UE. Clause 4.3.23 of 3GPP TS 23.502 V17.2.1, the disclosure of which is incorporated by reference herein in its entirety, may be referenced for the procedure of PDU session establishment.

According to clause 5.2.2.3.11 of 3GPP TS 29.502 V17.3.0, the disclosure of which is incorporated by reference herein in its entirety, when the AMF receives an “initial request” with PDU session ID which already exists in PDU session context of the UE, the AMF shall request the SMF to release the existing PDU session. Upon subsequent receipt of an SM context status notification indicating that the SM context has been deleted in the SMF, the AMF shall release the stored context for the PDU session and proceed with the “initial request” with the PDU session Id. Therefore if the AMF receives a PDU session establishment request from UE including a PDU session ID that already exists in the UE context, the AMF shall release existing SM Context for the existing PDU session and then proceed with the new request.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In a live 5GS, there is an observation that PDU session context with the same PDU session ID may exist in different SMF instances, e.g. “SMF1” and “SMF2” where “SMF2” is the “correct” SMF (i.e. the one known in the AMF), while “SMF1” is the “wrong” SMF.

Below are some possible reasons of the observed scenario.

Possible Reason-1: UE releases a PDU session with a PDU session ID1 which was established on SMF1, and AMF requests SMF1 to release the PDU session. However, the release request from the AMF did not reach SMF1 properly, which may result in that SMF1 does not handle PDU session context. Later UE establishes PDU session with the same PDU session ID1 towards SMF2.

Possible Reason-2: The AMF tries to set up PDU session with the PDU session ID1 on SMF1, but it takes too long time for SMF1 to send a response to AMF or the response does not reach AMF properly, which results in that AMF selects SMF2 to set up the SM context.

In the above observed scenarios, the same PDU session ID1 may exist in SMF1 and SMF2 where SMF2 is the correct SMF (i.e. the one known in the AMF), while SMF1 is the wrong SMF. If unfortunately, the SMF1 receives notification of downlink (DL) data, SMF1 will trigger user plane (UP) setup in next generation RAN (NG-RAN) by sending NIN2MessageTransfer to the AMF. Since currently the AMF is not able to determine that SMF1 is the wrong SMF, the AMF simply passes the N2 message to the NG-RAN resulting in PDU session resource setup. Later when the correct SMF2 requests the NG-RAN to set up the PDU session resource, the request will be rejected since the PDU session already exits, leading to a problem that the UE cannot get any service.

To overcome or mitigate at least one of above mentioned problems or other problems, an improved solution for session management may be desirable.

In a first aspect of the disclosure, there is provided a method performed by a first session management node. The method comprises receiving a deregistration notification of a protocol data unit (PDU) session of a user equipment from a data management node. The deregistration notification comprises a deregistration reason indicating duplicated PDU session. The method further comprises releasing at least one resource corresponding to the PDU session.

In an embodiment, the at least one resource comprises at least one of PDU session resource, session management (SM) context, SM policy association, or N4 user plane (UP) resource.

In an embodiment, the method further comprises skipping sending a SM context status notify about a status of SM context related to the PDU session in the first session management node to an access and mobility node.

In an embodiment, the access and mobility node comprises access and mobility function (AMF).

In an embodiment, the method further comprises sending a PDU session status notification about a status of PDU session resource related to the PDU session in the first session management node to a second session management node. The PDU session status notification indicates PDU session release due to duplicated PDU session.

In an embodiment, the second session management node comprises at least one of an intermediate session management function or a visited session management function.

In an embodiment, the method further comprises sending a request for subscribing a notification of duplicated PDU session to the data management node. The deregistration notification is received from the data management node in response to the request.

In an embodiment, the first session management node comprises a session management function (SMF) or home SMF.

In an embodiment, the data management node comprises a unified data management (UDM).

In an embodiment, the deregistration notification comprises Nudm_UECM_DeregistrationNotification.

In a second aspect of the disclosure, there is provided a method performed by a second session management node. The method comprises receiving a PDU session status notification about a status of PDU session resource related to a PDU session of a user equipment in a first session management node from the first session management node. The PDU session status notification indicates PDU session release due to duplicated PDU session. The method further comprises releasing at least one resource corresponding to the PDU session.

In an embodiment, the at least one resource comprises at least one of session management (SM) context, SM policy association, or N4 user plane (UP) resource.

In an embodiment, the method further comprises skipping sending a SM context status notify about a status of SM context related to the PDU session in the second session management node to an access and mobility node.

In an embodiment, the access and mobility node comprises access and mobility function (AMF).

In an embodiment, the second session management node comprises at least one of an intermediate session management function or a visited session management function.

In an embodiment, the first session management node comprises a session management function (SMF) or home SMF or an anchor SMF.

In a third aspect of the disclosure, there is provided a method performed by a data management node. The method comprises receiving a registration request from a new session management node. The registration request comprising an identifier of a PDU session of a user equipment. The method further comprises determining whether an old session management node has registered it as a serving network function of a PDU session of the user equipment with the identifier of the PDU session on the data management node. The method further comprises sending a deregistration notification of the PDU session comprising a deregistration reason indicating duplicated PDU session to the old session management node when the old session management node has registered it as the serving network function of the PDU session of the user equipment with the identifier of the PDU session on the data management node.

In an embodiment, the registration request is without a registration reason.

In an embodiment, the registration reason comprises session management (SM) context transfer.

In an embodiment, the registration request comprises a registration reason indicating checking and reporting duplicated PDU session.

In an embodiment, the new session management node and the old session management node comprise session management function (SMF).

In an embodiment, the data management node comprises unified data management (UDM).

In an embodiment, the deregistration notification comprises Nudm_UECM_DeregistrationNotification.

In an embodiment, the registration request comprises a Nudm_UECM_Registration request.

In a fourth aspect of the disclosure, there is provided a method performed by a session management node. The method comprises sending a request to an access and mobility node. The request comprises an identifier of a PDU session of a user equipment and first information. The first information comprises an identity of the session management node. The first information is used by the access and mobility node to determine whether the session management node is a correct session management node for serving the PDU session.

In an embodiment, the method further comprises receiving a response from the access and mobility node. The response comprises second information indicating that the session management node is not the correct session management node for serving the PDU session. The method further comprises releasing at least one resource corresponding to the PDU session.

In an embodiment, the second information comprises at least one of session management node mismatch, or invalid session management (SM) context.

In an embodiment, the at least one resource comprises at least one of session management (SM) context, PDU session resource, SM policy association, or N4 user plane (UP) resource.

In an embodiment, the method further comprises skipping sending a SM context status notify about a status of an SM Context related to the PDU session in the session management node to the access and mobility node.

In an embodiment, when the session management node is an intermediate session management node or a visited session management node, the method further comprises sending a request for releasing at least one resource corresponding to the PDU session to an anchor session management node or home session management node.

In an embodiment, the session management node comprises at least one of a home session management function (SMF), an anchor SMF or a visited SMF.

In an embodiment, the access and mobility node comprises access and mobility function (AMF).

In an embodiment, the request comprises Namf_Communication_NIN2MessageTransfer Request.

In a fifth aspect of the disclosure, there is provided a method performed by an access and mobility node. The method comprises receiving a request from a session management node. The request comprises an identifier of a PDU session of a user equipment and first information. The first information comprises an identity of the session management node. The first information is used by the access and mobility node to determine whether the session management node is a correct session management node for serving the PDU session. The method further comprises determining whether the session management node is a correct session management node for serving the PDU session based on the first information.

In an embodiment, determining whether the session management node is a correct session management node for serving the PDU session based on the first information comprises: when the received identity of the session management node is same as an identity of a session management node in a context for the PDU session stored in the access and mobility node, determining that the session management node is a correct session management node for serving the PDU session.

In an embodiment, determining whether the session management node is a correct session management node for serving the PDU session based on the first information comprises: when the received identity of the session management node is not same as an identity of a session management node in a context for the PDU session stored in the access and mobility node, determining that the session management node is not a correct session management node for serving the PDU session.

In an embodiment, the method further comprises when the session management node is the correct session management node for serving the PDU session, processing the request. The method further comprises sending a response to the session management node when the session management node is not the correct session management node for serving the PDU session. The response comprises second information indicating that the session management node is not the correct session management node for serving the PDU session.

In an embodiment, the second information comprises at least one of session management node mismatch, or invalid session management (SM) context.

In an embodiment, the session management node comprises at least one of a home session management function (SMF), an intermediate SMF or a visited SMF.

In an embodiment, the access and mobility node comprises access and mobility function (AMF).

In an embodiment, the request comprises Namf_Communication_NIN2MessageTransfer Request.

In a sixth aspect of the disclosure, there is provided a first session management node. The first session management node comprises a processor and a memory coupled to the processor. Said memory contains instructions executable by said processor. Said first session management node is operative to receive a deregistration notification of a protocol data unit (PDU) session of a user equipment from a data management node. The deregistration notification comprises a deregistration reason indicating duplicated PDU session. Said first session management node is further operative to release at least one resource corresponding to the PDU session.

In a seventh aspect of the disclosure, there is provided a second session management node. The second session management node comprises a processor and a memory coupled to the processor. Said memory contains instructions executable by said processor. Said second session management node is operative to receive a PDU session status notification about a status of PDU session resource related to a PDU session of a user equipment in a first session management node from the first session management node. The PDU session status notification indicates PDU session release due to duplicated PDU session. Said second session management node is further operative to release at least one resource corresponding to the PDU session.

In an eighth aspect of the disclosure, there is provided a data management node. The data management node comprises a processor and a memory coupled to the processor. Said memory contains instructions executable by said processor. Said data management node is operative to receive a registration request from a new session management node. The registration request comprising an identifier of a PDU session of a user equipment. Said data management node is further operative to determine whether an old session management node has registered it as a serving network function of a PDU session of the user equipment with the identifier of the PDU session on the data management node. Said data management node is further operative to send a deregistration notification of the PDU session comprising a deregistration reason indicating duplicated PDU session to the old session management node when the old session management node has registered it as the serving network function of the PDU session of the user equipment with the identifier of the PDU session on the data management node.

In a ninth aspect of the disclosure, there is provided a session management node. The session management node comprises a processor and a memory coupled to the processor. Said memory contains instructions executable by said processor. Said session management node is operative to send a request to an access and mobility node. The request comprises an identifier of a PDU session of a user equipment and first information. The first information comprises an identity of the session management node. The first information is used by the access and mobility node to determine whether the session management node is a correct session management node for serving the PDU session.

In a tenth aspect of the disclosure, there is provided an access and mobility node, comprises a processor and a memory coupled to the processor. Said memory contains instructions executable by said processor. Said access and mobility node is operative to receive a request from a session management node. The request comprises an identifier of a PDU session of a user equipment and first information. The first information comprises an identity of the session management node. The first information is used by the access and mobility node to determine whether the session management node is a correct session management node for serving the PDU session. Said access and mobility node is further operative to determine whether the session management node is a correct session management node for serving the PDU session based on the first information.

In an eleventh aspect of the disclosure, there is provided a first session management node. The first session management node comprises a receiving module configured to receive a deregistration notification of a protocol data unit (PDU) session of a user equipment from a data management node. The deregistration notification comprises a deregistration reason indicating duplicated PDU session. The first session management node further comprises a releasing module configured to release at least one resource corresponding to the PDU session.

In an embodiment, the first session management node further comprises a skipping module configured to skip sending a SM context status notify about a status of SM context related to the PDU session in the first session management node to an access and mobility node.

In an embodiment, the first session management node further comprises a first sending module configured to send a PDU session status notification about a status of PDU session resource related to the PDU session in the first session management node to a second session management node. The PDU session status notification indicates PDU session release due to duplicated PDU session

In an embodiment, the first session management node further comprises a second sending module configured to send a request for subscribing a notification of duplicated PDU session to the data management node. The deregistration notification is received from the data management node in response to the request.

In a twelfth aspect of the disclosure, there is provided is a second session management node. The second session management node comprises a receiving module configured to receive a PDU session status notification about a status of PDU session resource related to a PDU session of a user equipment in a first session management node from the first session management node. The PDU session status notification indicates PDU session release due to duplicated PDU session. The second session management node further comprises a releasing module configured to release at least one resource corresponding to the PDU session.

In an embodiment, the second session management node further comprises a skipping module configured to skip sending a SM context status notify about a status of SM context related to the PDU session in the second session management node to an access and mobility node.

In a thirteenth aspect of the disclosure, there is provided is a data management node. The data management node comprises a receiving module configured to receive a registration request from a new session management node. The registration request comprising an identifier of a PDU session of a user equipment. The data management node further comprises a determining module configured to determine whether an old session management node has registered it as a serving network function of a PDU session of the user equipment with the identifier of the PDU session on the data management node. The data management node further comprises a sending module configured to send a deregistration notification of the PDU session comprising a deregistration reason indicating duplicated PDU session to the old session management node when the old session management node has registered it as the serving network function of the PDU session of the user equipment with the identifier of the PDU session on the data management node.

In a fourteenth aspect of the disclosure, there is provided is a session management node. The session management node comprises a first sending module configured to send a request to an access and mobility node. The request comprises an identifier of a PDU session of a user equipment and first information. The first information comprises an identity of the session management node. The first information is used by the access and mobility node to determine whether the session management node is a correct session management node for serving the PDU session.

In an embodiment, the session management node further comprises a second receiving module configured to receive a response from the access and mobility node. The response comprises second information indicating that the session management node is not the correct session management node for serving the PDU session.

In an embodiment, the session management node further comprises a releasing module configured to release at least one resource corresponding to the PDU session.

In an embodiment, the session management node further comprises a skipping module configured to skip sending a SM context status notify about a status of an SM Context related to the PDU session in the session management node to the access and mobility node.

In an embodiment, when the session management node is an intermediate session management node or a visited session management node, the session management node further comprises a second sending module configured to send a request for releasing at least one resource corresponding to the PDU session to an anchor session management node or home session management node.

In a fifteenth aspect of the disclosure, there is provided is an access and mobility node. The access and mobility node comprises a receiving module configured to receive a request from a session management node. The request comprises an identifier of a PDU session of a user equipment and first information. The first information comprises an identity of the session management node. The first information is used by the access and mobility node to determine whether the session management node is a correct session management node for serving the PDU session. The access and mobility node further comprises a determining module configured to determine whether the session management node is a correct session management node for serving the PDU session based on the first information.

In an embodiment, when the first information is the information indicating the PDU session is restored on the session management node, the access and mobility node further comprises a storing module configured to store an identity of the session management node in a context for the PDU session in the access and mobility node.

In an embodiment, the access and mobility node further comprises a processing module configured to process the request when the session management node is the correct session management node for serving the PDU session.

In an embodiment, the access and mobility node further comprises a second sending module configured to send a response to the session management node when the session management node is not the correct session management node for serving the PDU session. The response comprises second information indicating that the session management node is not the correct session management node for serving the PDU session.

In a sixteenth aspect of the disclosure, there is provided, there is provided a computer program product comprising instructions which when executed by at least one processor, cause the at least one processor to perform the method according to any one of the first, second, third, fourth, or fifth aspects.

In seventeenth aspect of the disclosure, there is provided a computer-readable storage medium storing instructions which when executed by at least one processor, cause the at least one processor to perform the method according to any one of the first, second, third, fourth, or fifth aspects.

Embodiments herein may provide many advantages, of which a non-exhaustive list of examples follows. In some embodiments herein, it proposes a new mechanism to secure the cleanup of hanging PDU session when a new PDU session with same PDU session ID is (to be) established. In some embodiments herein, it introduces a mechanism to secure that the AMF can successfully handle the traffic from the active PDU session and reject the traffic from the hanging PDU session. In some embodiments herein, it can resolve the problem observed from the live network. In some embodiments herein, it can improve the user experience. In some embodiments herein, it can improve KPI (Key Performance Indicator) in NG-RAN (due to decrease of the failure cause code: multiple-PDU-Session-ID-Instances). The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows a high level architecture in the fifth generation network according to an embodiment of the present disclosure;

FIG. 2 shows a flowchart of Network Triggered Service Request according to an embodiment of the present disclosure;

FIG. 3 shows a flowchart of UE or network requested PDU session Release for non-roaming and roaming with local breakout according to an embodiment of the present disclosure;

FIG. 4 shows a flowchart of context transfer of a PDU session according to an embodiment of the present disclosure;

FIG. 5 shows an example of duplicated PDU session according to an embodiment of the present disclosure;

FIG. 6 shows a flowchart of a method according to an embodiment of the present disclosure;

FIG. 7 shows a flowchart of a method according to another embodiment of the present disclosure;

FIG. 8 shows a flowchart of a method according to another embodiment of the present disclosure;

FIG. 9 shows a flowchart of a method according to another embodiment of the present disclosure;

FIG. 10 shows a flowchart of a method according to another embodiment of the present disclosure;

FIG. 11 shows a flowchart of a method according to another embodiment of the present disclosure;

FIG. 12 shows a flowchart of a method according to another embodiment of the present disclosure;

FIG. 13 shows a flowchart of a method according to another embodiment of the present disclosure;

FIG. 14 shows a flowchart of a method according to another embodiment of the present disclosure;

FIG. 15 shows a flowchart of a method according to another embodiment of the present disclosure;

FIG. 16 shows a flowchart of a method according to another embodiment of the present disclosure;

FIG. 17 shows a flowchart of a method according to another embodiment of the present disclosure;

FIG. 18 shows a flowchart of a method according to another embodiment of the present disclosure;

FIG. 19 shows a flowchart of a method according to another embodiment of the present disclosure;

FIG. 20 shows a flowchart of a method according to another embodiment of the present disclosure;

FIG. 21 shows a flowchart of a method according to another embodiment of the present disclosure;

FIG. 22 shows a flowchart of PDU session deregistration according to an embodiment of the present disclosure;

FIG. 23 shows a flowchart of PDU session deregistration according to another embodiment of the present disclosure;

FIG. 24 shows a flowchart of PDU session deregistration according to another embodiment of the present disclosure;

FIG. 25 is a block diagram showing an apparatus suitable for practicing some embodiments of the disclosure;

FIG. 26 is a block diagram showing a first session management node according to an embodiment of the disclosure;

FIG. 27 is a block diagram showing a second session management node according to an embodiment of the disclosure;

FIG. 28 is a block diagram showing a data management node according to an embodiment of the disclosure;

FIG. 29 is a block diagram showing a session management node according to an embodiment of the disclosure; and

FIG. 30 is a block diagram showing an access and mobility node according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

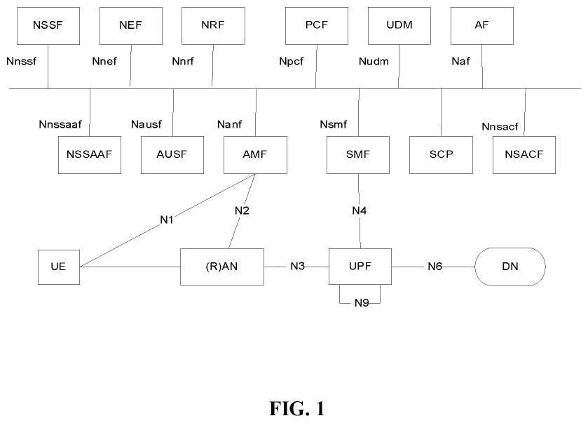

Although the subject matter described herein may be implemented in any appropriate type of system using any suitable components, the embodiments disclosed herein are described in relation to a communication system complied with the exemplary system architecture illustrated in FIG. 1. For simplicity, the system architecture of FIG. 1 only depicts some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

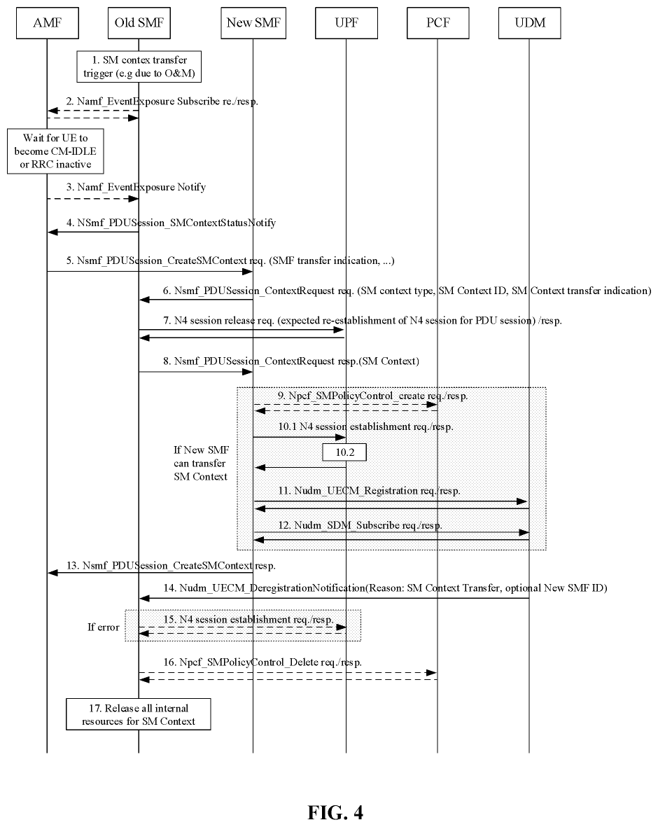

FIG. 1 schematically shows a high level architecture in the fifth generation network according to an embodiment of the present disclosure. For example, the fifth generation network may be 5GS. The architecture of FIG. 1 is same as FIG. 4.2.3-1 as described in 3GPP TS 23.501 V17.2.0, the disclosure of which is incorporated by reference herein in its entirety. The system architecture of FIG. 1 may comprise some exemplary elements such as AUSF, AMF, DN (data network), NEF, NRF, NSSF, PCF, SMF, UDM, UPF, AF, UE, (R) AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 1. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the DN (data network, e.g. an operator network or Internet) through the UPF over the reference point N6.

As further illustrated in FIG. 1, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 1 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 1 may be responsible for functions such as session management, mobility management, authentication, security, etc. The AUSF, AMF, DN, NEF, NRF, NSSF, PCF, SMF, UDM, UPF, AF, UE, (R) AN, SCP, NSACF may include the functionality for example as defined in clause 6.2 of 3GPP TS 23.501 V17.2.0.

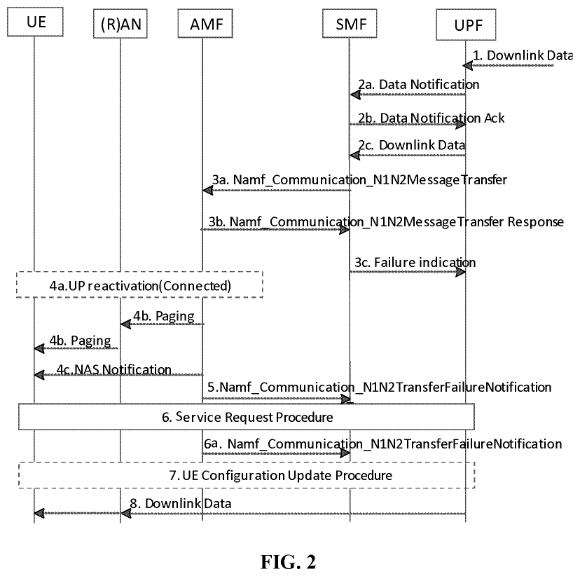

FIG. 2 shows a flowchart of Network Triggered Service Request according to an embodiment of the present disclosure, which is same as FIG. 4.2.3.3-1 of 3GPP TS 23.502 V17.2.1. The steps of FIG. 2 have been described in clause 4.2.3.3 of 3GPP TS 23.502 V17.2.1.

When downlink packet or signaling is received for a PDU session, the SMF may need to activate the UP resource and/or signal the UE. The SMF sends N1/N2 Message Transfer message (including the PDU session ID) to the AMF. See excerpt below from clause 4.2.3.3 of 3GPP TS 23.502 V17.2.1.

3a. [Conditional] SMF to AME: Namf Communication NIN2Message Transfer (SUPI, PDU Session ID, N1 SM container (SM message), N2 SM information (QFI(s), QoS profile(s), (′N N3 Tunnel Info, S-NSSAI), Area of validity for N2 SM information, ARP, Paging Policy Indicator, 5QI, NIN2TransferFailure Notification Target Address, Extended Buffering support), or NF to AME: Namf Communication NIN2Message Transfer (SUPI, N1 message).

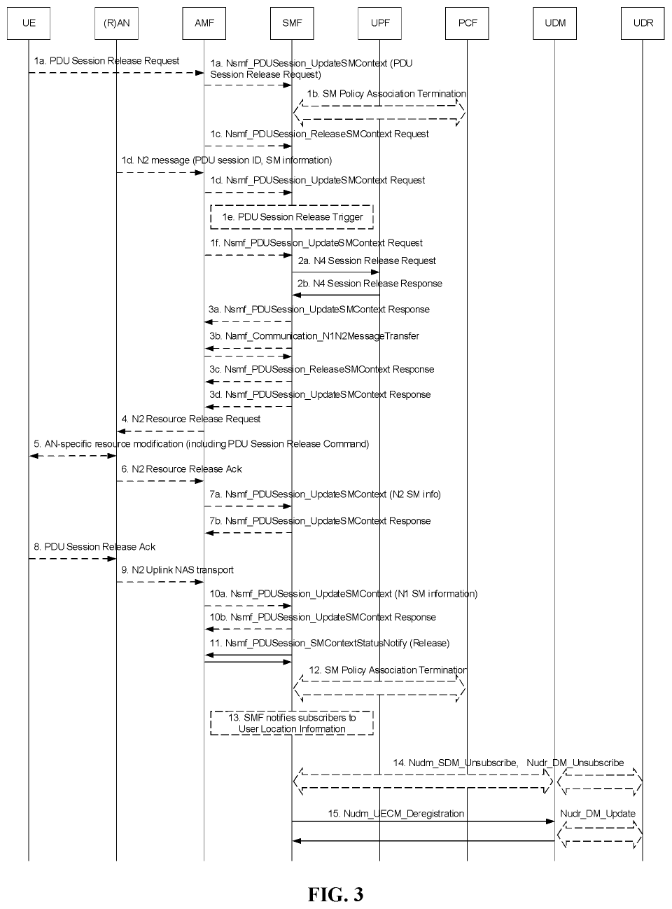

FIG. 3 shows a flowchart of UE or network requested PDU Session Release for non-roaming and roaming with local breakout according to an embodiment of the present disclosure, which is same as FIG. 4.3.4.2-1 of 3GPP TS 23.502 V17.2.1. The steps of FIG. 3 have been described in clause 4.3.4.2 of 3GPP TS 23.502 V17.2.1.

When the SMF releases the PDU session triggered by the network, the SMF sends a SM Context Status Notify to AMF to indicate the PDU session is released. See excerpt below from clause 4.3.4.2 of 3GPP TS 23.502 V17.2.1.

11. If steps 3a, 3b or 3d were performed, the SMF waits until it has received replies to the N1 and N2 information provided in step 3, as needed.

The SMF invokes Nsmf_PDUSession_SMContextStatusNotify to notify AMF that the SM context for this PDU Session is released. If the UPF included Small Data Rate Control Status and or APN Rate Control Status in step 2 then the SMF includes Small Data Rate Control Status and or APN Rate Control Status in its request to the AMF in this step. The AMF releases the association between the SMF ID and the PDU Session ID, DNN, as well as S-NSSAI and stores the Small Data Rate Control Status and or the APN Rate Control Status in the UE context in AME. The SMF shall remove any event subscriptions on the AMF that becomes no more needed due to the PDU Session Release.

FIG. 4 shows a flowchart of context transfer of a PDU session according to an embodiment of the present disclosure, which is same as FIG. 4.26.4.1.1-1 of 3GPP TS 23.502 V17.2.1. The steps of FIG. 4 have been described in clause 4.26.5.3 of 3GPP TS 23.502 V17.2.1.

Per 3GPP TS 23.502 V17.2.1 clause 4.26.5.3, when a new SMF registers in UDM for the purpose of SMF context transfer (see step 11 below), the UDM invokes UECM Deregistration notification to the old SMF to clean up PDU Session resource in the old SMF and its surrounding entities (see step 14 below). See excerpt below from clause 4.26.5.3 of 3GPP TS 23.502 V17.2.1.

11. New SMF registers to UDM. The information stored at the UDM includes SUPI, SMF identity and the associated DNN and PDU Session ID.

12. New SMF subscribes to subscription changes for the UE.

13. From New SMF to AMF: Nsmf_PDUSession_CreateSMContext response. If this response indicates a redirect (e.g. another SMF in the set), the procedure moves to step 5 with the indicated endpoint address as target.

14. UDM notifies Old SMF that it is deregistered for the PDU Session by sending Nudm_UECM_DeregistrationNotification, optionally including New SMF ID

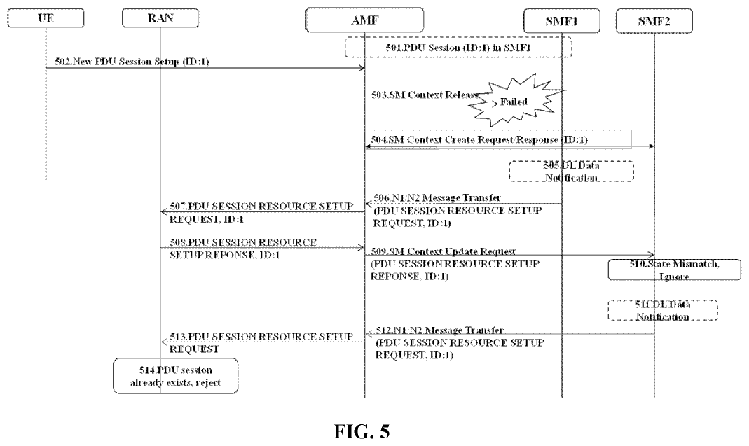

FIG. 5 shows an example of duplicated PDU session according to an embodiment of the present disclosure.

At step 501. PDU session with PDU session ID: 1 was established in SMF1.

At step 502. UE sends a new PDU session Setup with PDU session ID: 1 to AMF.

At step 503. AMF requests SMF1 to release the PDU session. However, the SM release request from the AMF did not reach SMF1 properly, which results in that SMF1 does not release PDU session or SM context in SMF1.

At step 504. AMF sends SM Context Create Request with PDU session ID: 1 to SMF2, and SMF2 sends SM Context Create Response with PDU session ID: 1 to AMF.

At step 505. SMF1 receives DL (downlink) Data Notification.

At step 506. SMF1 sends N1/N2 Message Transfer (PDU SESSION RESOURCE

SETUP REQUEST, PDU session ID: 1) to AMF.

At step 507. AMF sends PDU SESSION RESOURCE SETUP REQUEST with PDU session ID: 1 to RAN.

At step 508. RAN sends PDU SESSION RESOURCE SETUP REPONSE with PDU session ID: 1 to AMF.

At step 509. AMF sends SM Context Update Request (PDU SESSION RESOURCE SETUP REPONSE, PDU session ID: 1) to SMF2

At step 510. SMF2 determines State Mismatch and ignores the SM Context Update Request.

At step 511. SMF2 receives DL Data Notification.

At step 512. SMF2 sends N1/N2 Message Transfer (PDU SESSION RESOURCE SETUP REQUEST, PDU session ID: 1) to AMF.

At step 513. AMF sends PDU SESSION RESOURCE SETUP REQUEST with PDU session ID: 1 to RAN

At step 514. Since PDU session already exists, RAN rejects the PDU SESSION RESOURCE SETUP REQUEST.

The messages of FIG. 5 may be same as the corresponding messages as described in 3GPP TS 23.502 V17.2.1.

In the above scenario, it may lead to a problem that the UE cannot get any service.

To address the problems of the observed scenario that PDU session context with the same PDU session ID exists in different SMF instances and the UE cannot get any service, several solutions are proposed herein.

Solution-1: UDM triggering the cleanup of duplicated PDU session resource in the (old) SMF.

UDM enhancement: when an SMF registers in UDM at PDU session establishment, the UDM checks if any PDU session with the same PDU session ID exists. If yes, UDM invokes UECM deregistration service operation to the (old) SMF which holds the duplicated PDU session with a new deregistration reason, e.g. “Duplicated PDU session”.

Note: Currently registration reason (e.g. SM Context Transfer) is not included by SMF at UECM registration for PDU session establishment.

SMF enhancement: Upon reception of UECM deregistration notification with the new deregistration reason (e.g. “Duplicated PDU session”), the SMF releases the SM context and surrounding resources (e.g. SM Policy Association, N4 UP resource, etc.). Moreover, the SMF does not send a SM Context Status Notify to the AMF because the AMF should keep the PDU session context with the new SMF.

For PDU session with I-SMF/V-SMF (intermediate SMF or visited SMF), the SMF (or H-SMF (home SMF)) explicitly indicates to the I-SMF/V-SMF that the PDU session is to be released due to duplicated PDU session ID, so that I-SMF/V-SMF will not send the SM Context Status Notify to AMF accordingly.

Solution-2: AMF rejects the N1/N2 message transfer request from the (old and wrong) SMF.

In this solution, when the SMF sends N1/N2 message Transfer to AMF, the SMF includes additional information for the AMF to determine whether the SMF is the correct one. There are different options about what additional information the SMF may include.

Solution-2-1: SMF include additionally the SMF ID in N1/N2 message Transfer.

For case without involving PDU session restoration with SMF Set, the SMF includes the SMF ID (NF Instance ID of the SMF) in the N1/N2 Message Transfer message. AMF compares the SMF ID with the stored SMF ID for the PDU session in the UE context and only process the communication if they are matched.

For case involving PDU session restoration with SMF Set, where the SMF ID may change when a new SMF within the SMF Set taking over the PDU session, the SMF will not include the SMF ID in the NIN2MessageTransfer after PDU session restoration, until the SM Context Status Notify indicating the SMF relocation is successfully acknowledged by the AMF. Alternatively, the SMF may include an explicit flag indicating the PDU session is restored on a new SMF, i.e. the AMF shall allow the N1/ N2 Message Transfer message and also store the new SMF ID in the UE context.

Solution-2-2: AMF generates a PDU session token for a PDU session and SMF includes a corresponding token in the N1/N2 Message Transfer message.

At PDU session establishment, the AMF allocates a PDU session token (which is unique per PDU session for one UE), and send the token to the SMF. The token is stored in the SM Context in SMF and PDU session context in AMF.

When the SMF sends a N1/N2 Message Transfer message to the AMF, the SMF includes additionally the token and AMF checks the PDU session context to identify the active SM context.

During UE mobility with AMF change, the token needs to be transferred between AMFs. During PDU session restoration and/or SM Context Transfer with SMF change, the token need to be transferred or restored in the new SMF.

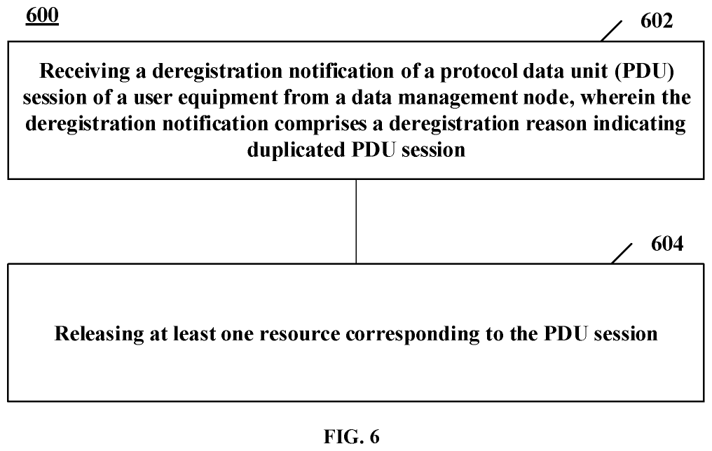

FIG. 6 shows a flowchart of a method according to an embodiment of the present disclosure, which may be performed by an apparatus implemented in or at or as a first session management node or communicatively coupled to the first session management node. As such, the apparatus may provide means or modules for accomplishing various parts of the method 600 as well as means or modules for accomplishing other processes in conjunction with other components.

At block 602, the first session management node may receive a deregistration notification of a protocol data unit (PDU) session of a user equipment from a data management node. The deregistration notification comprises a deregistration reason indicating duplicated PDU session.

The first session management node may be any suitable network node which can provide session management function. In an embodiment, the first session management node may comprise a session management function (SMF) or a home SMF.

The data management node may be any suitable network node which can provide data management function. In an embodiment, the data management node may comprises a unified data management (UDM).

In an embodiment, the deregistration notification may be Nudm_UECM_DeregistrationNotification as described in 3GPP TS 23.502 V17.2.1 except that it further comprises a deregistration reason indicating duplicated PDU session.

In an embodiment, the data management node may determine that PDU session context with the same PDU session ID of the user equipment exists in different SMF instances. For example, an old session management node has registered in the data management node such as UDM at an establishment of a PDU session with a specified PDU session ID of the user equipment. Later a new session management node may register in the data management node at an establishment of a PDU session with the same specified PDU session ID of the user equipment. In this case the data management node may determine that PDU session with the same PDU session ID of the user equipment exists in different SMF instances. The data management node may send the deregistration notification to the old session management node rather than the new session management node.

At block 604, the first session management node may release at least one resource corresponding to the PDU session. The at least one resource corresponding to the PDU session may comprise any suitable resource related to the PDU session. For example, the at least one resource corresponding to the PDU session may comprise computing resource, storage resource, networking resource consumed by the first session management node to establish and/or maintain the PDU session.

In an embodiment, the at least one resource comprises at least one of PDU session resource, session management (SM) context, SM policy association, or N4 user plane (UP) resource.

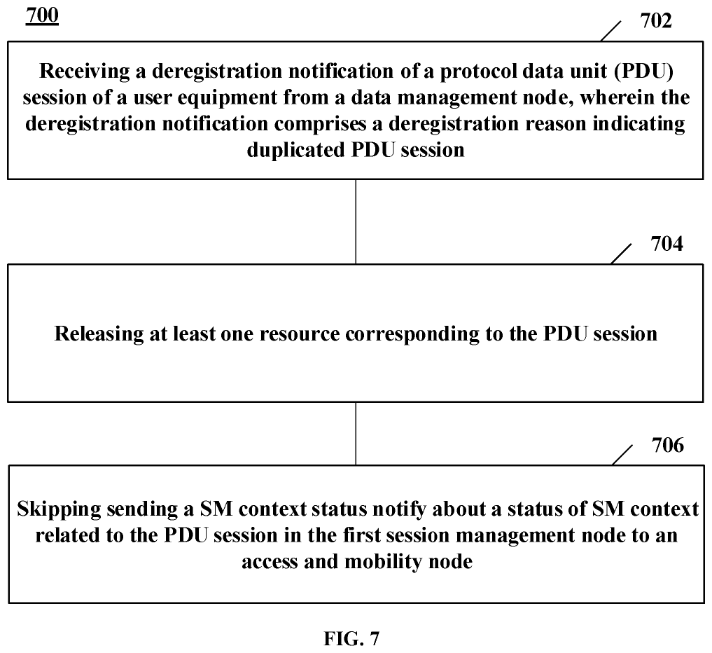

FIG. 7 shows a flowchart of a method according to another embodiment of the present disclosure, which may be performed by an apparatus implemented in or at or as a first session management node or communicatively coupled to the first session management node. As such, the apparatus may provide means or modules for accomplishing various parts of the method 700 as well as means or modules for accomplishing other processes in conjunction with other components. For some parts which have been described in the above embodiments, the description thereof is omitted here for brevity.

In this embodiment, there is no intermediate session management function or visited session management function for the PDU session.

At block 702, the first session management node may receive a deregistration notification of a protocol data unit (PDU) session of a user equipment from a data management node. The deregistration notification comprises a deregistration reason indicating duplicated PDU session. Block 702 is same as block 602 of FIG. 6.

At block 704, the first session management node may release at least one resource corresponding to the PDU session. Block 704 is same as block 604 of FIG. 6.

At block 706, the first session management node may skip sending a SM context status notify about a status of SM context related to the PDU session in the first session management node to an access and mobility node. The first session management node such as SMF does not send a SM Context Status Notify to the access and mobility node such as AMF because the access and mobility node such as AMF should keep the PDU session context with a new SMF. The PDU session context in AMF should not be changed in this embodiment.

The access and mobility node may be any suitable network node which can provide access and mobility function. In an embodiment, the access and mobility node comprises access and mobility management function (AMF).

In an embodiment, the SM context status notify may be same as Nsmf_PDUSession_SMContextStatusNotify as described in 3GPP TS 23.502 V17.2.1.

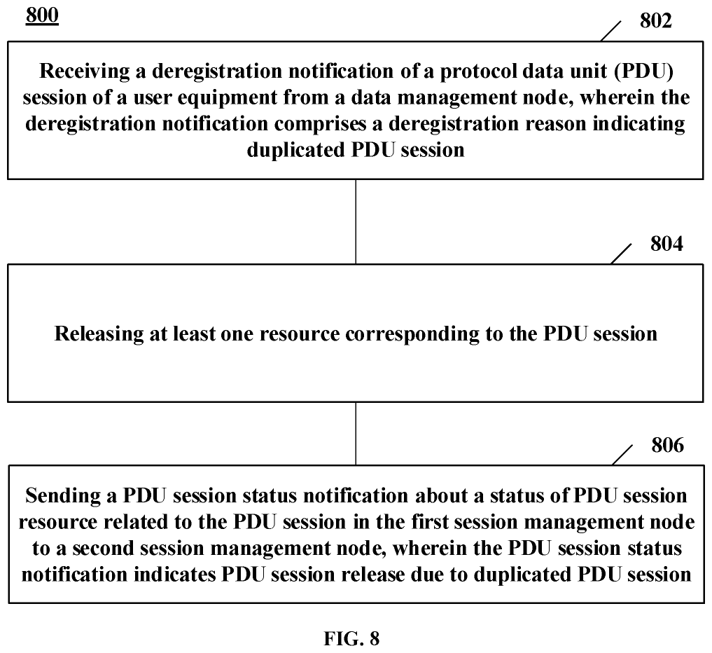

FIG. 8 shows a flowchart of a method according to another embodiment of the present disclosure, which may be performed by an apparatus implemented in or at or as a first session management node or communicatively coupled to the first session management node. As such, the apparatus may provide means or modules for accomplishing various parts of the method 800 as well as means or modules for accomplishing other processes in conjunction with other components. For some parts which have been described in the above embodiments, the description thereof is omitted here for brevity.

In this embodiment, there is an intermediate session management function or a visited session management function for the PDU session.

At block 802, the first session management node may receive a deregistration notification of a protocol data unit (PDU) session of a user equipment from a data management node. The deregistration notification comprises a deregistration reason indicating duplicated PDU session. Block 802 is same as block 602 of FIG. 6.

At block 804, the first session management node may release at least one resource corresponding to the PDU session. Block 804 is same as block 604 of FIG. 6.

At block 806, the first session management node may send a PDU session status notification about a status of PDU session resource related to the PDU session in the first session management node to a second session management node. The PDU session status notification indicates PDU session release due to duplicated PDU session.

In an embodiment, the second session management node comprises at least one of an intermediate session management function or a visited session management function.

In an embodiment, the SM context status notify may be same as Nsmf_PDUSession_SMContextStatusNotify as described in 3GPP TS 23.502 V17.2.1 except that it indicates PDU session release due to duplicated PDU session.

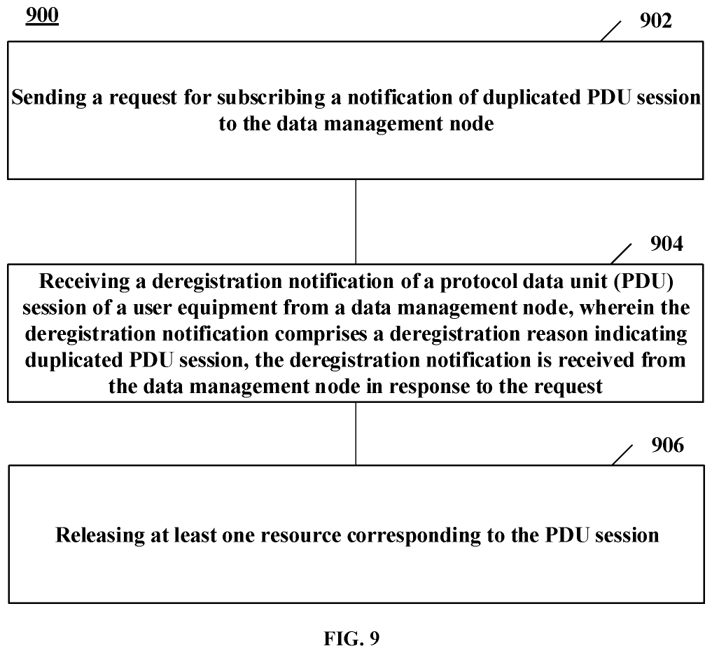

FIG. 9 shows a flowchart of a method according to another embodiment of the present disclosure, which may be performed by an apparatus implemented in or at or as a first session management node or communicatively coupled to the first session management node. As such, the apparatus may provide means or modules for accomplishing various parts of the method 900 as well as means or modules for accomplishing other processes in conjunction with other components. For some parts which have been described in the above embodiments, the description thereof is omitted here for brevity.

At block 902, the first session management node may send a request for subscribing a notification of duplicated PDU session to the data management node.

In an embodiment, the subscription may be implicitly created by the first session management node providing the notification URI (Uniform Resource Identifier) in the a register request. In another embodiment, the subscription may be an explicit subscribe request.

At block 904, the first session management node may receive a deregistration notification of a protocol data unit (PDU) session of a user equipment from a data management node. The deregistration notification comprises a deregistration reason indicating duplicated PDU session. The deregistration notification is received from the data management node in response to the request sent at block 902.

At block 906, the first session management node may release at least one resource corresponding to the PDU session. Block 906 is same as block 604 of FIG. 6.

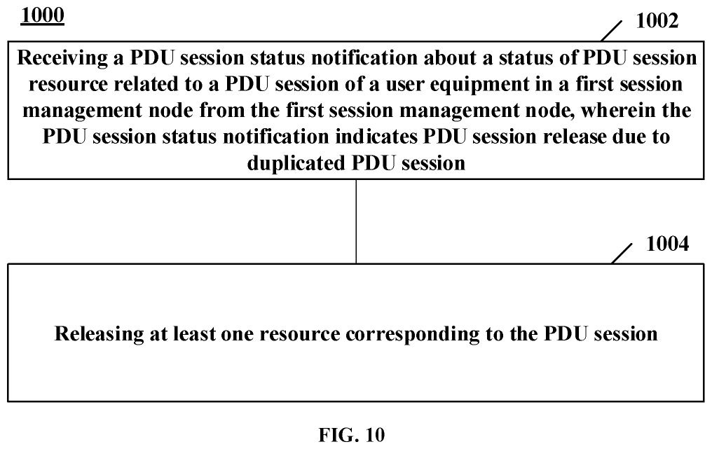

FIG. 10 shows a flowchart of a method according to another embodiment of the present disclosure, which may be performed by an apparatus implemented in or at or as a second session management node or communicatively coupled to the second session management node. As such, the apparatus may provide means or modules for accomplishing various parts of the method 1000 as well as means or modules for accomplishing other processes in conjunction with other components. For some parts which have been described in the above embodiments, the description thereof is omitted here for brevity.

At block 1002, the second session management node may receive a PDU session status notification about a status of PDU session resource related to a PDU session of a user equipment in a first session management node from the first session management node. The PDU session status notification indicates PDU session release due to duplicated PDU session.

For example, the first session management node may send the PDU session status notification about a status of PDU session resource related to the PDU session in the first session management node to the second session management node at block 806 of FIG. 8, and then the second session management node may receive the PDU session status notification.

At block 1004, the second session management node may release at least one resource corresponding to the PDU session.

In an embodiment, the at least one resource comprises at least one of session management (SM) context, SM policy association, or N4 user plane (UP) resource.

In an embodiment, the second session management node comprises at least one of an intermediate session management function or a visited session management function.

In an embodiment, the first session management node comprises a session management function (SMF) or home SMF or an anchor SMF.

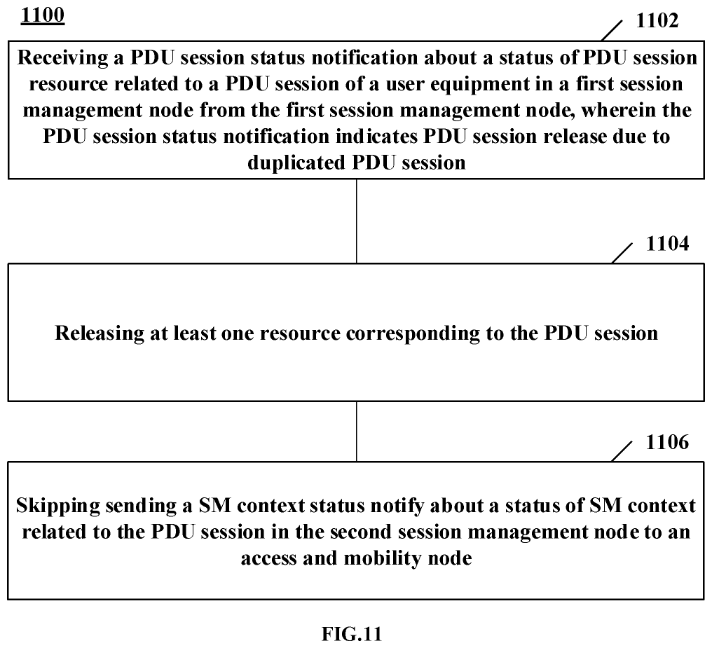

FIG. 11 shows a flowchart of a method according to another embodiment of the present disclosure, which may be performed by an apparatus implemented in or at or as a second session management node or communicatively coupled to the second session management node. As such, the apparatus may provide means or modules for accomplishing various parts of the method 1100 as well as means or modules for accomplishing other processes in conjunction with other components. For some parts which have been described in the above embodiments, the description thereof is omitted here for brevity.

At block 1102, the second session management node may receive a PDU session status notification about a status of PDU session resource related to a PDU session of a user equipment in a first session management node from the first session management node. The PDU session status notification indicates PDU session release due to duplicated PDU session. Block 1102 is same as block 1002 of FIG. 10.

At block 1104, the second session management node may release at least one resource corresponding to the PDU session. Block 1104 is same as block 1004 of FIG. 10.

At block 1106, the second session management node may skip sending a SM context status notify about a status of SM context related to the PDU session in the second session management node to an access and mobility node.

The second session management node such as V-SMF or I-SMF does not send a SM Context Status Notify to the access and mobility node such as AMF because the access and mobility node such as AMF should keep the PDU session context with a new SMF. The PDU session context in AMF should not be changed in this embodiment.

In an embodiment, the access and mobility node comprises access and mobility function (AMF).

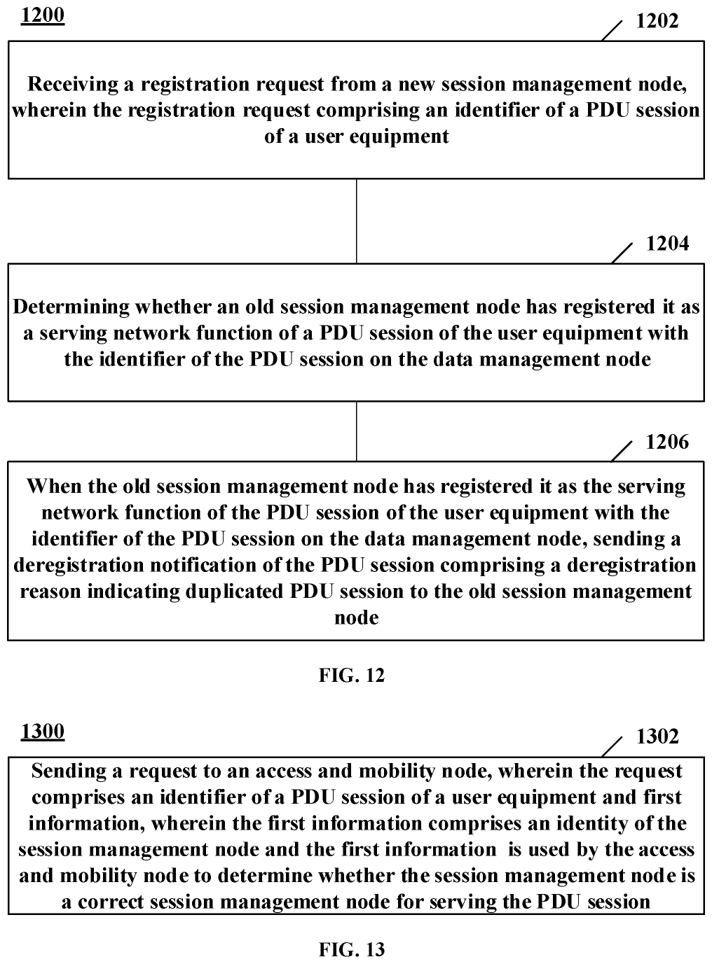

FIG. 12 shows a flowchart of a method according to another embodiment of the present disclosure, which may be performed by an apparatus implemented in or at or as a data management node or communicatively coupled to the data management node. As such, the apparatus may provide means or modules for accomplishing various parts of the method 1200 as well as means or modules for accomplishing other processes in conjunction with other components. For some parts which have been described in the above embodiments, the description thereof is omitted here for brevity.

At block 1202, the data management node may receive a registration request from a new session management node. The registration request comprising an identifier of a PDU session of a user equipment.

The registration request may be used to register PDU session's serving NF on the UDM.

In an embodiment, the registration request may be same as Nudm_UECM_Registration Request message as described in 3GPP TS 23.502 V17.2.1.

In an embodiment, the registration request is without a registration reason.

In an embodiment, the registration reason comprises session management (SM) context transfer.

In an embodiment, if the registration request is without a registration reason of SM context transfer, the data management node may perform blocks 1204 and 1206. Otherwise the data management node may process the registration request for example according to the method of FIG. 4.

In an embodiment, the registration request comprises a registration reason indicating checking and reporting duplicated PDU session. In this embodiment, the data management node may perform blocks 1204 and 1206.

At block 1204, the data management node may determine whether an old session management node has registered it as a serving network function of a PDU session of the user equipment with the identifier of the PDU session on the data management node.

At block 1206, the data management node may send a deregistration notification of the PDU session comprising a deregistration reason indicating duplicated PDU session to the old session management node when the old session management node has registered it as the serving network function of the PDU session of the user equipment with the identifier of the PDU session on the data management node.

In an embodiment, the new session management node and the old session management node comprise session management function (SMF).

In an embodiment, the data management node comprises unified data management (UDM).

In an embodiment, the deregistration notification comprises Nudm_UECM_DeregistrationNotification.

FIG. 13 shows a flowchart of a method according to another embodiment of the present disclosure, which may be performed by an apparatus implemented in or at or as a session management node or communicatively coupled to the session management node. As such, the apparatus may provide means or modules for accomplishing various parts of the method 1300 as well as means or modules for accomplishing other processes in conjunction with other components. For some parts which have been described in the above embodiments, the description thereof is omitted here for brevity.

At block 1302, the session management node may send a request to an access and mobility node. The request comprises an identifier of a PDU session of a user equipment and first information. The first information is used by the access and mobility node to determine whether the session management node is a correct session management node for serving the PDU session.

In an embodiment, the first information comprises an identity of the session management node.

In an embodiment, the session management node comprises at least one of a home session management function (SMF), an anchor SMF or a visited SMF.

In an embodiment, the access and mobility node comprises access and mobility function (AMF).

In an embodiment, the first information comprises at least one of an identity of the session management node, information indicating the PDU session is restored on the session management node, or a token of the PDU session.

For example, the identity of the session management node may be SMF ID as described in 3GPP TS 23.502 V17.2.1.

The session management node may obtain the first information in various ways. For example, the session management node may obtain the identity of the session management node and/or the token of the PDU session from the access and mobility node. The session management node may obtain the information indicating the PDU session is restored on the session management node during PDU session restoration with session management node set.

For example, equivalent control plane NFs may be grouped into NF Sets, e.g. several SMF instances are grouped into an SMF Set. NFs within a NF Set are interchangeable because they share the same context data, and may be deployed in different locations, e.g. different data centers.

In an embodiment, when the first information is an identity of the session management node and the PDU session is restored on the session management node, the identity of the session management node is not comprised in the request after PDU session restoration, until a SM Context Status Notify indicating session management node relocation is successfully acknowledged by the access and mobility node.

In an embodiment, the request may comprise Namf_Communication_NIN2MessageTransfer Request as described in 3GPP TS 23.502 V17.2.1 except that it further comprises the first information.

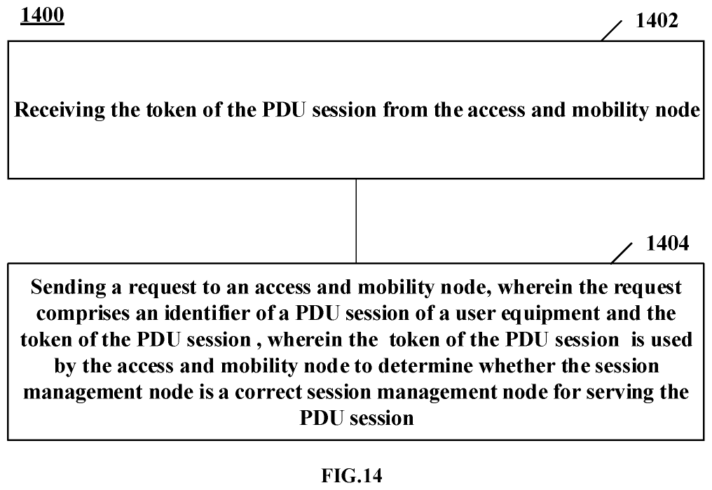

FIG. 14 shows a flowchart of a method according to another embodiment of the present disclosure, which may be performed by an apparatus implemented in or at or as a session management node or communicatively coupled to the session management node. As such, the apparatus may provide means or modules for accomplishing various parts of the method 1400 as well as means or modules for accomplishing other processes in conjunction with other components. For some parts which have been described in the above embodiments, the description thereof is omitted here for brevity.

At block 1402, the session management node may receive the token of the PDU session from the access and mobility node.

In an embodiment, the token of the PDU session is received from the access and mobility node in an SM context create request. For example, the SM context create request may be same as Nsmf_PDUSession_CreateSMContext Request as described in 3GPP TS 23.502 V17.2.1 except that it further comprises the token of the PDU session.

At PDU session establishment, the access and mobility node such as AMF may allocate the PDU session token. The PDU session token may be unique per PDU session for a UE.

In an embodiment, the token is stored in a session management (SM) context for the PDU session and transferred between session management nodes as a part of the SM context during a restoration of session management node or an insertion or change or removal of intermediate session management node or visited session management node.

At block 1404, the session management node may send a request to the access and mobility node. The request comprises an identifier of a PDU session of a user equipment and the token of the PDU session. The token of the PDU session may be used by the access and mobility node to determine whether the session management node is a correct session management node for serving the PDU session.

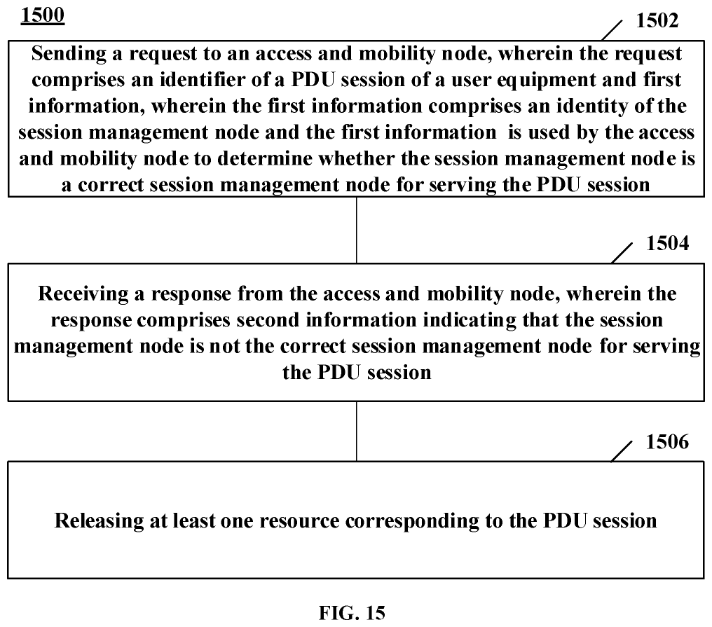

FIG. 15 shows a flowchart of a method according to another embodiment of the present disclosure, which may be performed by an apparatus implemented in or at or as a session management node or communicatively coupled to the session management node. As such, the apparatus may provide means or modules for accomplishing various parts of the method 1500 as well as means or modules for accomplishing other processes in conjunction with other components. For some parts which have been described in the above embodiments, the description thereof is omitted here for brevity.

At block 1502, the session management node may send a request to an access and mobility node. The request comprises an identifier of a PDU session of a user equipment and first information. The first information comprises an identity of the session management node and is used by the access and mobility node to determine whether the session management node is a correct session management node for serving the PDU session. Block 1502 is same as block 1302 of FIG. 13.

At block 1504, the session management node may receive a response from the access and mobility node. The response comprises second information indicating that the session management node is not the correct session management node for serving the PDU session.

The second information may be of any suitable forms such as bit, indication, flag, etc. In an embodiment, the second information comprises at least one of session management node mismatch, or invalid session management (SM) context.

At block 1506, the session management node may release at least one resource corresponding to the PDU session.

In an embodiment, the at least one resource comprises at least one of session management (SM) context, PDU session resource, SM policy association, or N4 user plane (UP) resource.

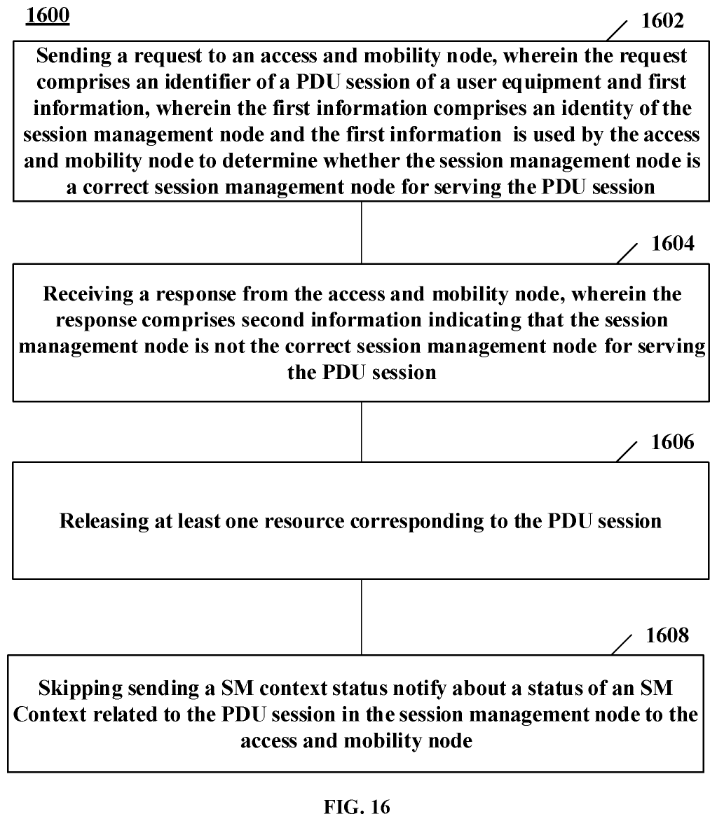

FIG. 16 shows a flowchart of a method according to another embodiment of the present disclosure, which may be performed by an apparatus implemented in or at or as a session management node or communicatively coupled to the session management node. As such, the apparatus may provide means or modules for accomplishing various parts of the method 1600 as well as means or modules for accomplishing other processes in conjunction with other components. For some parts which have been described in the above embodiments, the description thereof is omitted here for brevity.

In this embodiment, there is no intermediate session management function or visited session management function for the PDU session.

At block 1602, the session management node may send a request to an access and mobility node. The request comprises an identifier of a PDU session of a user equipment and first information. The first information comprises an identity of the session management node. The first information is used by the access and mobility node to determine whether the session management node is a correct session management node for serving the PDU session. Block 1602 is same as block 1502 of FIG. 15.

At block 1604, the session management node may receive a response from the access and mobility node. The response comprises second information indicating that the session management node is not the correct session management node for serving the PDU session. Block 1604 is same as block 1504 of FIG. 15.

At block 1606, the session management node may release at least one resource corresponding to the PDU session. Block 1606 is same as block 1506 of FIG. 15.

At block 1608, the session management node may skip sending a SM context status notify about a status of an SM Context related to the PDU session in the session management node to the access and mobility node. The session management node such as SMF does not send a SM Context Status Notify to the access and mobility node such as AMF because the access and mobility node such as AMF should keep the PDU session context with a new SMF. The PDU session context in AMF should not be changed in this embodiment.

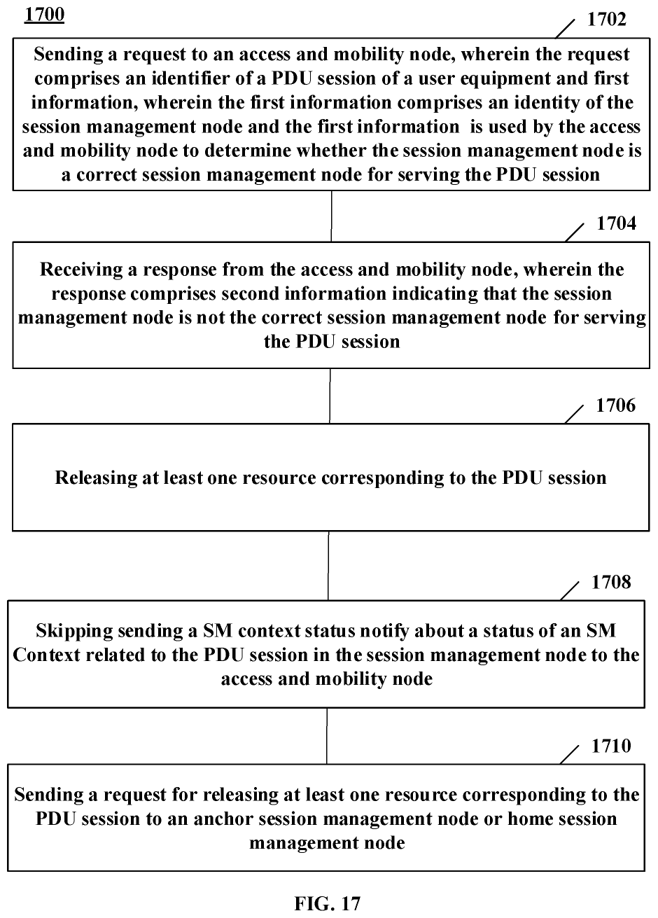

FIG. 17 shows a flowchart of a method according to another embodiment of the present disclosure, which may be performed by an apparatus implemented in or at or as a session management node or communicatively coupled to the session management node. As such, the apparatus may provide means or modules for accomplishing various parts of the method 1700 as well as means or modules for accomplishing other processes in conjunction with other components. For some parts which have been described in the above embodiments, the description thereof is omitted here for brevity.

In this embodiment, there is an intermediate session management function or visited session management function for the PDU session. The session management node is the intermediate session management node or the visited session management node.

At block 1702, the session management node may send a request to an access and mobility node. The request comprises an identifier of a PDU session of a user equipment and first information. The first information comprises an identity of the session management node. The first information is used by the access and mobility node to determine whether the session management node is a correct session management node for serving the PDU session. Block 1702 is same as block 1602 of FIG. 16.

At block 1704, the session management node may receive a response from the access and mobility node. The response comprises second information indicating that the session management node is not the correct session management node for serving the PDU session. Block 1704 is same as block 1604 of FIG. 16.

At block 1706, the session management node may release at least one resource corresponding to the PDU session. Block 1706 is same as block 1606 of FIG. 16.

At block 1708, the session management node may skip sending a SM context status notify about a status of an SM Context related to the PDU session in the session management node to the access and mobility node. Block 1708 is same as block 1608 of FIG. 16.

At block 1710, the session management node may send a request for releasing at least one resource corresponding to the PDU session to an anchor session management node or home session management node.

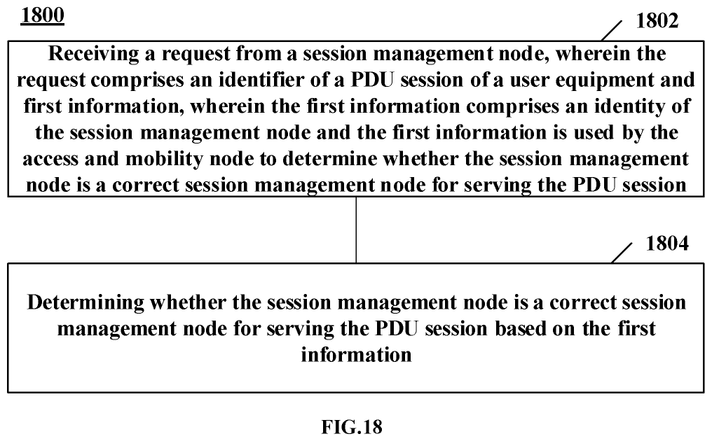

FIG. 18 shows a flowchart of a method according to another embodiment of the present disclosure, which may be performed by an apparatus implemented in or at or as an access and mobility node or communicatively coupled to the access and mobility node. As such, the apparatus may provide means or modules for accomplishing various parts of the method 1800 as well as means or modules for accomplishing other processes in conjunction with other components. For some parts which have been described in the above embodiments, the description thereof is omitted here for brevity.

At block 1802, the access and mobility node may receive a request from a session management node. The request comprises an identifier of a PDU session of a user equipment and first information. The first information is used by the access and mobility node to determine whether the session management node is a correct session management node for serving the PDU session. For example, the session management node may send the request to the access and mobility node at block 1302 of FIG. 13, and then the access and mobility node may receive the request from the session management node.

In an embodiment, the first information comprises an identity of the session management node.

In an embodiment, the first information comprises at least one of an identity of the session management node, information indicating the PDU session is restored on the session management node, or a token of the PDU session.

In an embodiment, the session management node comprises at least one of a home session management function (SMF), an intermediate SMF or a visited SMF.

In an embodiment, when the first information is an identity of the session management node and the PDU session is restored on the session management node, the identity of the session management node is not comprised in the request after PDU session restoration, until a SM Context Status Notify indicating session management node relocation is successfully acknowledged by the access and mobility node.

In an embodiment, the access and mobility node comprises access and mobility function (AMF).

In an embodiment, the request comprises Namf_Communication_NIN2MessageTransfer Request.

At block 1804, the access and mobility node may determine whether the session management node is a correct session management node for serving the PDU session based on the first information.

For example, the access and mobility node such as AMF may determine whether the identity of the session management node and/or the token of the PDU session included in request such as Namf_Communication_NIN2MessageTransfer Request match the stored identity of the session management node and/or the stored token of the PDU session. If they are matched, the access and mobility node may determine that the session management node is the correct session management node for serving the PDU session (i.e. the request is from the “correct” session management node) and the access and mobility node may further process the request. Otherwise the access and mobility node may reject the request and send a response comprising information indicating that the session management node is not the correct session management node for serving the PDU session to the session management node.

As another example, when the first information is the information indicating the PDU session is restored on the session management node, the access and mobility node may determine that the session management node is the correct session management node for serving the PDU session (i.e. the request is from the “correct” session management node) and the access and mobility node may further process the request. Otherwise the access and mobility node may reject the request and send a response comprising information indicating that the session management node is not the correct session management node for serving the PDU session to the session management node.

In an embodiment, when the received identity of the session management node is same as an identity of a session management node in a context for the PDU session stored in the access and mobility node, the access and mobility node may determine that the session management node is a correct session management node for serving the PDU session.

In an embodiment, when the received identity of the session management node is not same as an identity of a session management node in a context for the PDU session stored in the access and mobility node, the access and mobility node may determine that the session management node is not a correct session management node for serving the PDU session.

In an embodiment, when the received token of the PDU session is same as a token of a PDU session in a context for the PDU session stored in the access and mobility node, the access and mobility node may determine that the session management node is a correct session management node for serving the PDU session.

In an embodiment, when the received token of the PDU session is not same as a token of the PDU session in a context for the PDU session stored in the access and mobility node, the access and mobility node may determine that the session management node is not a correct session management node for serving the PDU session.

In an embodiment, when the first information is the information indicating the PDU session is restored on the session management node, the access and mobility node may determine that the session management node is a correct session management node for serving the PDU session.

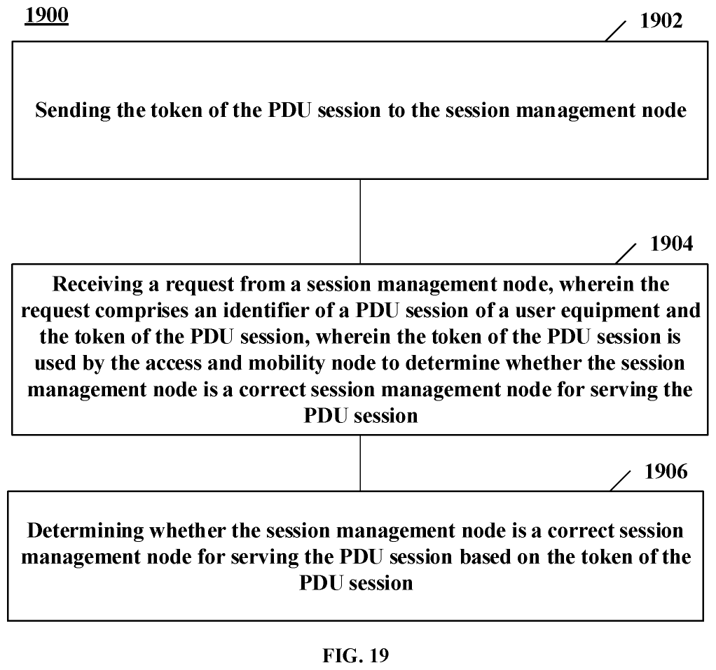

FIG. 19 shows a flowchart of a method according to another embodiment of the present disclosure, which may be performed by an apparatus implemented in or at or as an access and mobility node or communicatively coupled to the access and mobility node. As such, the apparatus may provide means or modules for accomplishing various parts of the method 1900 as well as means or modules for accomplishing other processes in conjunction with other components. For some parts which have been described in the above embodiments, the description thereof is omitted here for brevity.

At block 1902, the access and mobility node may send the token of the PDU session to the session management node.

In an embodiment, the token of the PDU session is sent to the session management node in an SM context create request.

In an embodiment, the token of the PDU session is stored in PDU session context in user equipment context and transferred between access and mobility nodes during user equipment mobility.

At block 1904, the access and mobility node may receive a request from a session management node. The request comprises an identifier of a PDU session of a user equipment and the token of the PDU session. The token of the PDU session is used by the access and mobility node to determine whether the session management node is a correct session management node for serving the PDU session.

At block 1906, the access and mobility node may determine whether the session management node is a correct session management node for serving the PDU session based on the token of the PDU session.

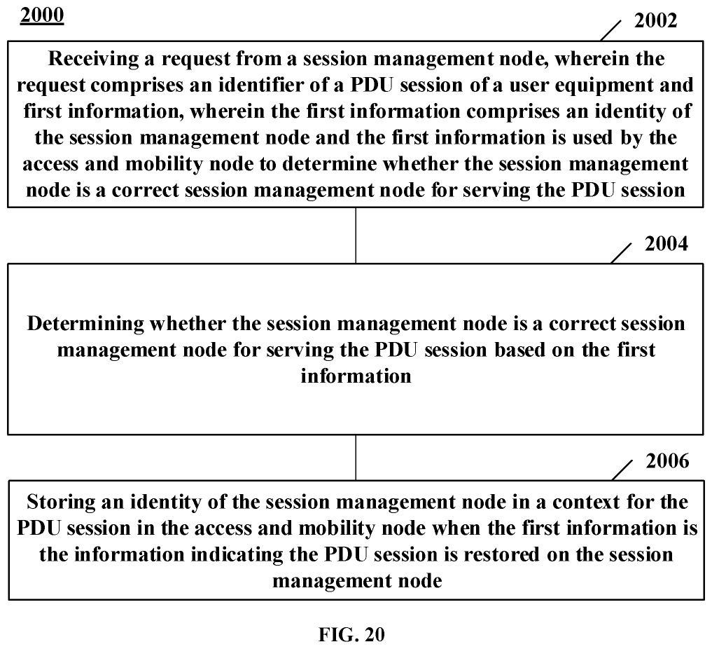

FIG. 20 shows a flowchart of a method according to another embodiment of the present disclosure, which may be performed by an apparatus implemented in or at or as an access and mobility node or communicatively coupled to the access and mobility node. As such, the apparatus may provide means or modules for accomplishing various parts of the method 2000 as well as means or modules for accomplishing other processes in conjunction with other components. For some parts which have been described in the above embodiments, the description thereof is omitted here for brevity.

At block 2002, the access and mobility node may receive a request from a session management node. The request comprises an identifier of a PDU session of a user equipment and first information. The first information comprises an identity of the session management node. The first information is used by the access and mobility node to determine whether the session management node is a correct session management node for serving the PDU session.

At block 2004, the access and mobility node may determine whether the session management node is a correct session management node for serving the PDU session based on the first information. When the first information is the information indicating the PDU session is restored on the session management node, the access and mobility node may determine that the session management node is a correct session management node for serving the PDU session.

At block 2006, when the first information is the information indicating the PDU session is restored on the session management node, the access and mobility node may store an identity of the session management node in a context for the PDU session in the access and mobility node.

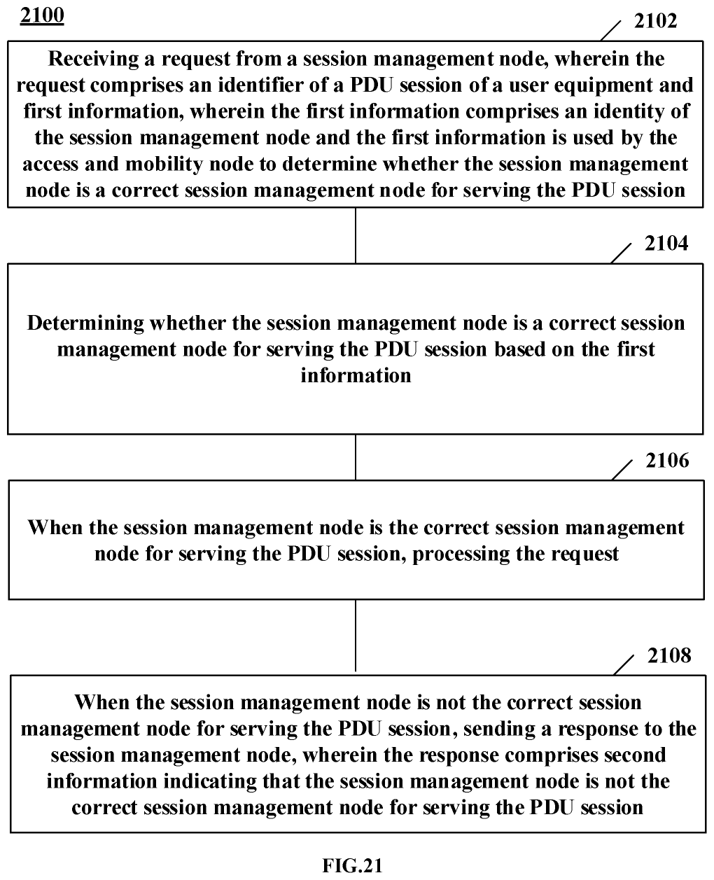

FIG. 21 shows a flowchart of a method according to another embodiment of the present disclosure, which may be performed by an apparatus implemented in or at or as an access and mobility node or communicatively coupled to the access and mobility node. As such, the apparatus may provide means or modules for accomplishing various parts of the method 2100 as well as means or modules for accomplishing other processes in conjunction with other components. For some parts which have been described in the above embodiments, the description thereof is omitted here for brevity.

At block 2102, the access and mobility node may receive a request from a session management node. The request comprises an identifier of a PDU session of a user equipment and first information. The first information comprises an identity of the session management node. The first information is used by the access and mobility node to determine whether the session management node is a correct session management node for serving the PDU session.

At block 2104, the access and mobility node may determine whether the session management node is a correct session management node for serving the PDU session based on the first information.

At block 2106, the access and mobility node may process the request when the session management node is the correct session management node for serving the PDU session.

At block 2108, the access and mobility node may send a response to the session management node when the session management node is not the correct session management node for serving the PDU session. The response comprises second information indicating that the session management node is not the correct session management node for serving the PDU session.

In an embodiment, the second information comprises at least one of session management node mismatch, or invalid session management (SM) context.

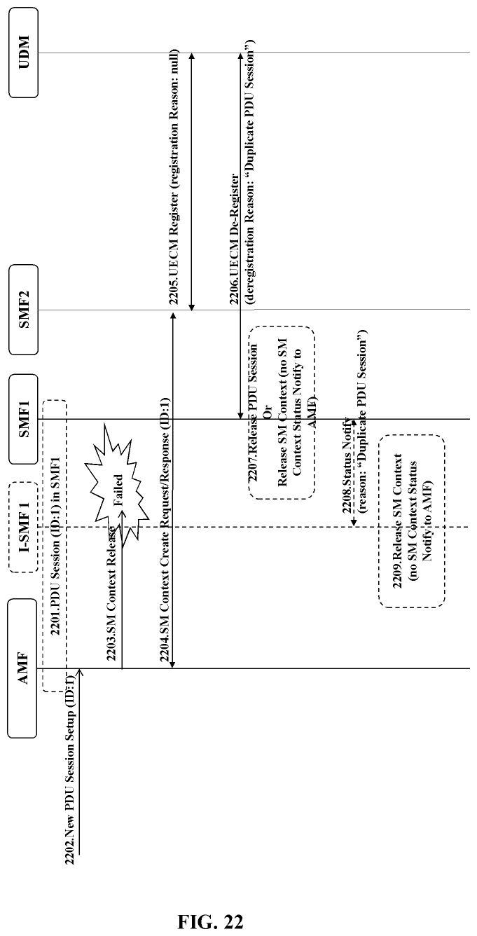

FIG. 22 shows a flowchart of PDU session deregistration according to an embodiment of the present disclosure.

Step 2201. PDU session with PDU session ID: 1 was established in SMF1.

Step 2202. UE sends a new PDU session Setup with PDU session ID: 1 to AMF.

Step 2203. AMF requests SMF1 to release the PDU session. However, the SM release request from the AMF did not reach SMF1 properly, which results in that SMF1 does not release PDU session or SM context in SMF1.

Step 2204. AMF sends SM Context Create Request with PDU session ID: 1 to SMF2, and SMF2 sends SM Context Create Response with PDU session ID: 1 to AMF.

Step 2205. SMF2 sends UECM Register request (registration reason: null) to UDM to register a serving NF of a PDU session of the UE in UDM with PDU session ID: 1. Alternatively the registration reason may indicate the UDM to check if any PDU session with the same PDU session ID of the UE exists. And the SMF2 receives UECM Register response from UDM.

Step 2206, the UDM checks if any PDU session with the same PDU session ID of the UE exists. If yes, UDM sends a UECM Deregistration Notification to SMF1 with a specific deregistration reason, e.g. “Duplicate PDU session”.

Step 2207. If no I-SMF/V-SMF for the PDU session, the SMFs receives Deregistration Notification with the specific deregistration reason (e.g. “Duplicate PDU session”) and will release the SM context and surrounding resources. The SMFs shall NOT send a SM Context Status Notify to AMF.

Step 2208. For PDU session with I-SMF/V-SMF, the SMF1 receives Deregistration Notification with the specific deregistration reason (e.g. “Duplicate PDU session”) and will release the PDU session and surrounding resources and send a Status Notify to the I-SMF/V-SMF with a specific reason (e.g. “Duplicated PDU session”). shall delete the SM context and NOT send a SM Context Status Notify to AMF.

Step 2209. The I-SMF/V-SMF shall delete the SM context and NOT send a SM Context Status Notify to AMF.

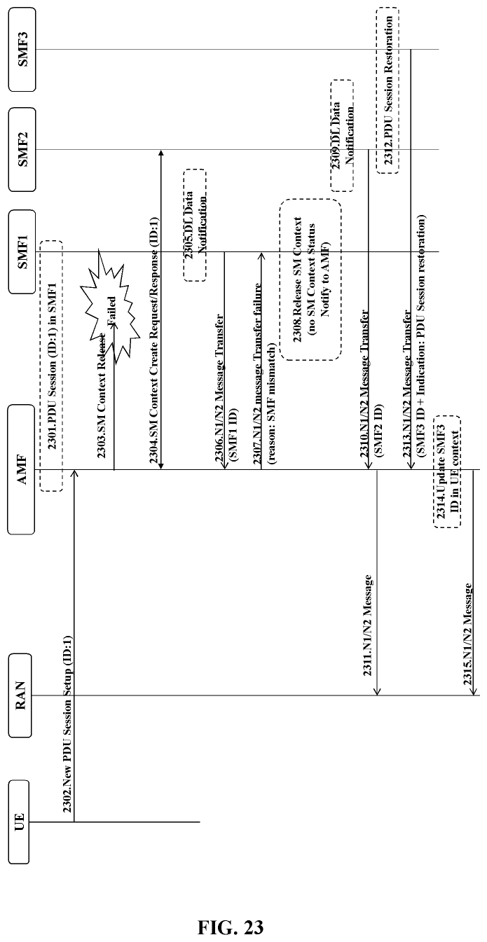

FIG. 23 shows a flowchart of PDU session deregistration according to another embodiment of the present disclosure.

Step 2301. PDU session with PDU session ID: 1 was established in SMF1.

Step 2302. UE sends a new PDU session Setup with PDU session ID: 1 to AMF.

Step 2303. AMF requests SMF1 to release the PDU session. However, the SM release request from the AMF did not reach SMF1 properly, which results in that SMF1 does not release PDU session or SM context in SMF1.

Step 2304. AMF sends SM Context Create Request with PDU session ID: 1 to SMF2, and SMF2 sends SM Context Create Response with PDU session ID: 1 to AMF. SMF2 sends UECM Register request (registration reason: null) to UDM to register a serving NF of a PDU session of the UE in UDM with PDU session ID: 1. And the SMF2 receives UECM Register response from UDM.

Step 2305. SMF1 receives DL Data Notification.

Step 2306. SMF1 sends N1/N2 Message Transfer (SMF1 ID) to AMF.

Step 2307. AMF verifies whether the SMF ID included in N1/N2 Message Transfer matches the stored SMF ID. If they are matched (i.e. the message is from the “correct” SMF), AMF further processes the N1/N2 Message Transfer.

When AMF identifies the SMF ID included in N1/N2 Message Transfer is different than the stored SMF ID (i.e. the message is from the “wrong” SMF), AMF rejects the N1/N2 Message Transfer with specific application error (e.g. “SMF mismatch”).

Step 2308. SMF1 releases SM Context and surrounding resources. SMF1 does not send SM Context Status Notify to AMF.

Step 2309. Later, SMF2 receives DL Data Notification.

Step 2310. SMF2 sends N1/N2 Message Transfer (SMF2 ID) to AMF.

Step 2311. AMF verifies that the SMF2 ID included in N1/N2 Message Transfer matches the stored SMF ID (i.e. the message is from the “correct” SMF) and further processes the N1/N2 Message Transfer. AMF sends N1/N2 Message to RAN.

Step 2312. Later, PDU session Restoration is performed from SMF2 to SMF3.

Step 2313. SMF3 sends N1/N2 Message Transfer (SMF3 ID and Indication: PDU session restoration) to AMF.

Step 2314. AMF updates SMF3 ID in UE context, i.e., SMF2 ID in UE context is replaced with SMF3 ID.

Step 2315. AMF sends N1/N2 Message to RAN.

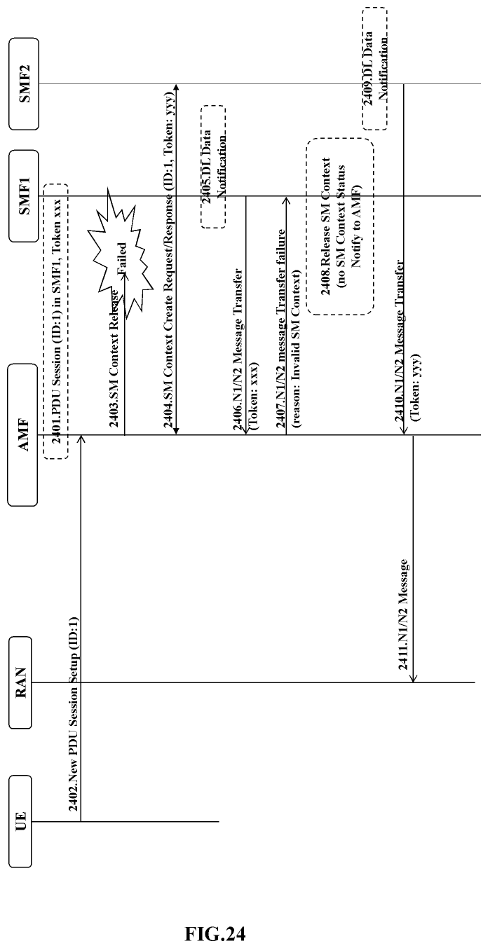

FIG. 24 shows a flowchart of PDU session deregistration according to another embodiment of the present disclosure.

Step 2401. PDU session with PDU session ID: 1 was established in SMF1.

Step 2402. UE sends a new PDU session Setup with PDU session ID: 1 to AMF.

Step 2403. AMF requests SMF1 to release the PDU session. However, the SM release request from the AMF did not reach SMF1 properly, which results in that SMF1 does not release PDU session or SM context in SMF1.

Step 2404. AMF sends SM Context Create Request with PDU session ID: 1 and Token: yyy to SMF2, and SMF2 sends SM Context Create Response with PDU session ID: 1 and Token: yyy to AMF. “yyy” may be any suitable value. SMF2 sends UECM Register request (registration reason: null) to UDM to register a serving NF of a PDU session of the UE in UDM with PDU session ID: 1 and Token: yyy. And the SMF2 receives UECM Register response from UDM.

Step 2405. SMF1 receives DL Data Notification.

Step 2406. SMF1 sends N1/N2 Message Transfer (Token: xxx) to AMF. “xxx” may be any suitable value.

Step 2407. AMF verifies whether the Token: xxx included in N1/N2 Message Transfer matches the stored Token: yyy. If they are matched (i.e. the message is from the “correct” SMF), AMF further processes the N1/N2 Message Transfer.

When AMF identifies the Token: xxx included in N1/N2 Message Transfer is different than the stored Token: yyy (i.e. the message is from the “wrong” SMF), AMF rejects the N1/N2 Message Transfer with specific application error (e.g. “Invalid SM Context”).

Step 2408. SMF1 releases SM Context and surrounding resources. SMF1 does not send SM Context Status Notify to AMF.

Step 2409. Later, SMF2 receives DL Data Notification.

Step 2410. SMF2 sends N1/N2 Message Transfer (Token: yyy) to AMF.

Step 2411. AMF verifies that the Token: yyy included in N1/N2 Message Transfer matches the stored Token: yyy (i.e. the message is from the “correct” SMF) and further processes the N1/N2 Message Transfer. AMF sends N1/N2 Message to RAN.

Some messages of FIGS. 22-24 may be same as the corresponding messages as described in 3GPP TS 23.502 V17.2.1. Some messages of FIGS. 22-24 are enhanced based on the embodiments of the present disclosure.

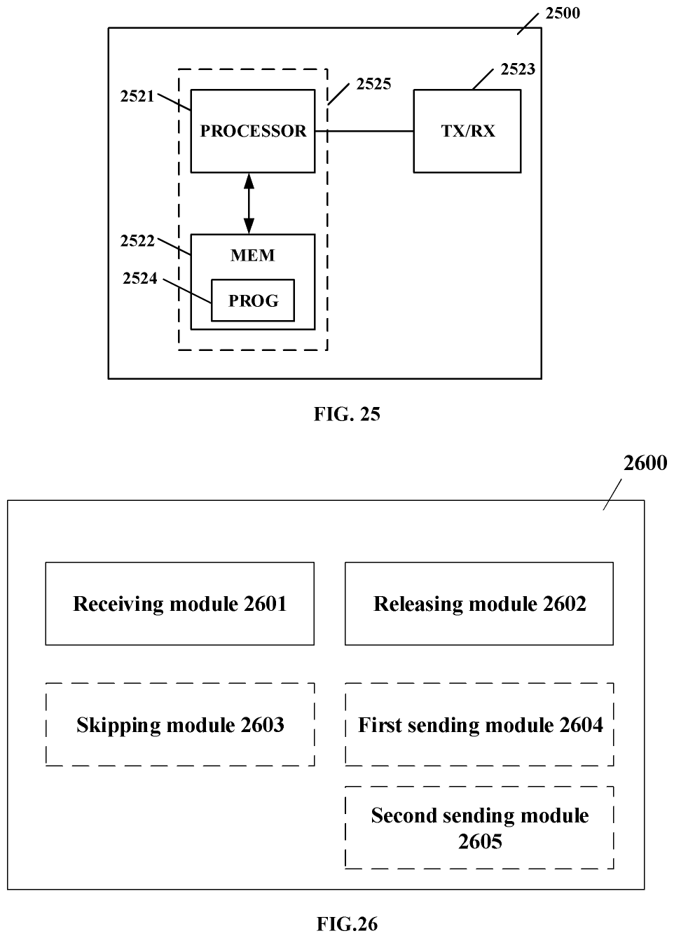

FIG. 25 is a block diagram showing an apparatus suitable for practicing some embodiments of the disclosure. For example, any one of the first session management node, the second session management node, the data management node, the session management node, or the access and mobility node described above may be implemented as or through the apparatus 2500.

The apparatus 2500 comprises at least one processor 2521, such as a digital processor (DP), and at least one memory (MEM) 2522 coupled to the processor 2521. The apparatus 2500 may further comprise a transmitter TX and receiver RX 2523 coupled to the processor 2521. The MEM 2522 stores a program (PROG) 2524. The PROG 2524 may include instructions that, when executed on the associated processor 2521, enable the apparatus 2500 to operate in accordance with the embodiments of the present disclosure. A combination of the at least one processor 2521 and the at least one MEM 2522 may form processing means 2525 adapted to implement various embodiments of the present disclosure.

Various embodiments of the present disclosure may be implemented by computer program executable by one or more of the processor 2521, software, firmware, hardware or in a combination thereof.

The MEM 2522 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 2521 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first session management node, the memory 2522 contains instructions executable by the processor 2521, whereby the first session management node operates according to any of the methods related to the first session management node as described above.

In an embodiment where the apparatus is implemented as or at the second session management node, the memory 2522 contains instructions executable by the processor 2521, whereby the second session management node operates according to any of the methods related to the second session management node as described above.

In an embodiment where the apparatus is implemented as or at the data management node, the memory 2522 contains instructions executable by the processor 2521, whereby the data management node operates according to any of the methods related to the data management node as described above.

In an embodiment where the apparatus is implemented as or at the session management node, the memory 2522 contains instructions executable by the processor 2521, whereby the session management node operates according to any of the methods related to the session management node as described above.

In an embodiment where the apparatus is implemented as or at the access and mobility node, the memory 2522 contains instructions executable by the processor 2521, whereby the access and mobility node operates according to any of the methods related to the access and mobility node as described above.

FIG. 26 is a block diagram showing a first session management node according to an embodiment of the disclosure. As shown, the first session management node 2600 comprises a receiving module 2601 configured to receive a deregistration notification of a protocol data unit (PDU) session of a user equipment from a data management node. The deregistration notification comprises a deregistration reason indicating duplicated PDU session. The first session management node 2600 further comprises a releasing module 2602 configured to release at least one resource corresponding to the PDU session.

In an embodiment, the first session management node 2600 further comprises a skipping module 2603 configured to skip sending a SM context status notify about a status of SM context related to the PDU session in the first session management node to an access and mobility node.

In an embodiment, the first session management node 2600 further comprises a first sending module 2604 configured to send a PDU session status notification about a status of PDU session resource related to the PDU session in the first session management node to a second session management node. The PDU session status notification indicates PDU session release due to duplicated PDU session

In an embodiment, the first session management node 2600 further comprises a second sending module 2605 configured to send a request for subscribing a notification of duplicated PDU session to the data management node. The deregistration notification is received from the data management node in response to the request.

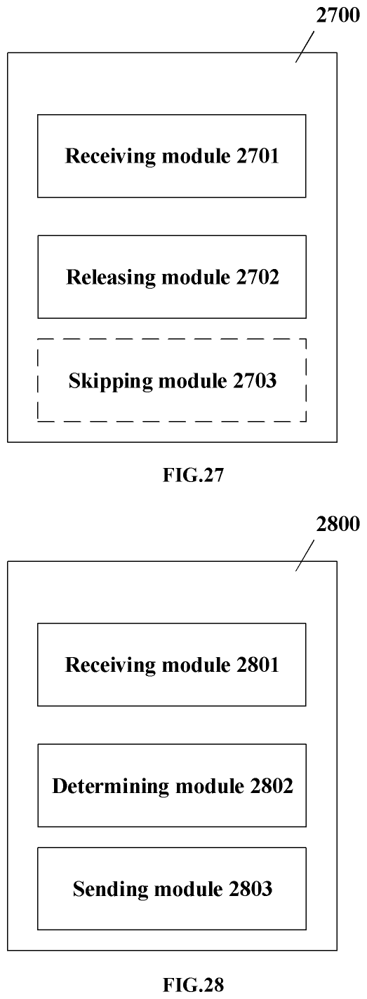

FIG. 27 is a block diagram showing a second session management node according to an embodiment of the disclosure. As shown, the second session management node 2700 comprises a receiving module 2701 configured to receive a PDU session status notification about a status of PDU session resource related to a PDU session of a user equipment in a first session management node from the first session management node. The PDU session status notification indicates PDU session release due to duplicated PDU session. The second session management node 2700 further comprises a releasing module 2702 configured to release at least one resource corresponding to the PDU session.

In an embodiment, the second session management node 2700 further comprises a skipping module 2703 configured to skip sending a SM context status notify about a status of SM context related to the PDU session in the second session management node to an access and mobility node.

FIG. 28 is a block diagram showing a data management node according to an embodiment of the disclosure. As shown, the data management node 2800 comprises a receiving module 2801 configured to receive a registration request from a new session management node. The registration request comprising an identifier of a PDU session of a user equipment. The data management node 2800 further comprises a determining module 2802 configured to determine whether an old session management node has registered it as a serving network function of a PDU session of the user equipment with the identifier of the PDU session on the data management node. The data management node 2800 further comprises a sending module 2803 configured to send a deregistration notification of the PDU session comprising a deregistration reason indicating duplicated PDU session to the old session management node when the old session management node has registered it as the serving network function of the PDU session of the user equipment with the identifier of the PDU session on the data management node.

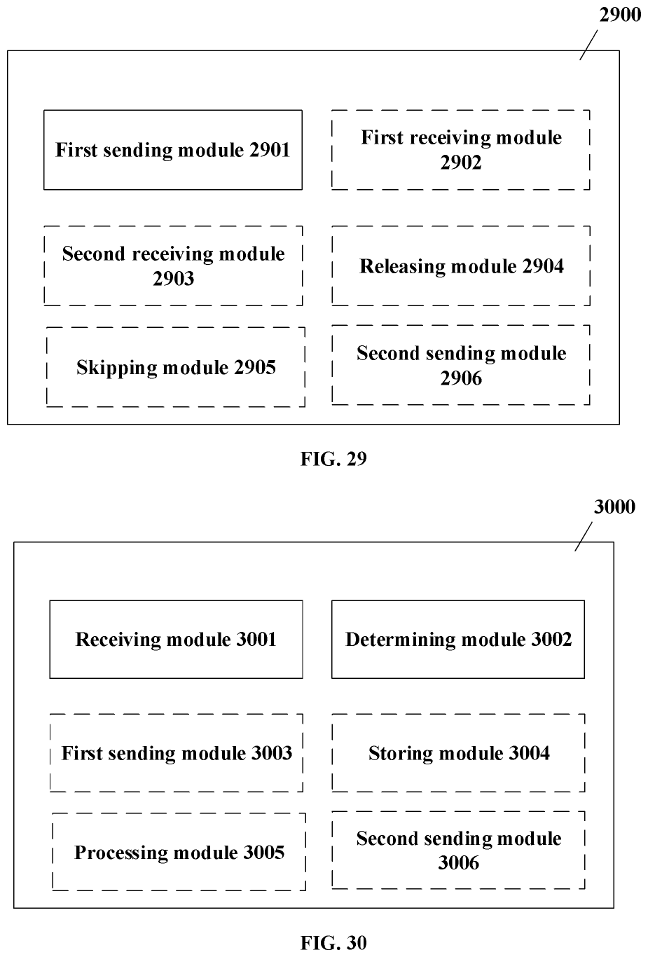

FIG. 29 is a block diagram showing a session management node according to an embodiment of the disclosure. As shown, the session management node 2900 comprises a first sending module 2901 configured to send a request to an access and mobility node, the request comprises an identifier of a PDU session of a user equipment and first information. The first information comprises an identity of the session management node. The first information is used by the access and mobility node to determine whether the session management node is a correct session management node for serving the PDU session.

In an embodiment, the session management node 2900 further comprises a first receiving module 2902 configured to receive the token of the PDU session from the access and mobility node.

In an embodiment, the session management node 2900 further comprises a second receiving module 2903 configured to receive a response from the access and mobility node. The response comprises second information indicating that the session management node is not the correct session management node for serving the PDU session.

In an embodiment, the session management node 2900 further comprises a releasing module 2904 configured to release at least one resource corresponding to the PDU session.

In an embodiment, the session management node 2900 further comprises a skipping module 2905 configured to skip sending a SM context status notify about a status of an SM Context related to the PDU session in the session management node to the access and mobility node.

In an embodiment, when the session management node is an intermediate session management node or a visited session management node, the session management node 2900 further comprises a second sending module 2906 configured to send a request for releasing at least one resource corresponding to the PDU session to an anchor session management node or home session management node.

FIG. 30 is a block diagram showing an access and mobility node according to an embodiment of the disclosure. As shown, the access and mobility node 3000 comprises a receiving module 3001 configured to receive a request from a session management node. The request comprises an identifier of a PDU session of a user equipment and first information. The first information comprises an identity of the session management node. The first information is used by the access and mobility node to determine whether the session management node is a correct session management node for serving the PDU session. The access and mobility node 3000 further comprises a determining module 3002 configured to determine whether the session management node is a correct session management node for serving the PDU session based on the first information.

In an embodiment, the access and mobility node 3000 further comprises a first sending module 3003 configured to send the token of the PDU session to the session management node.

In an embodiment, when the first information is the information indicating the PDU session is restored on the session management node, the access and mobility node 3000 further comprises a storing module 3004 configured to store an identity of the session management node in a context for the PDU session in the access and mobility node.

In an embodiment, the access and mobility node 3000 further comprises a processing module 3005 configured to process the request when the session management node is the correct session management node for serving the PDU session.

In an embodiment, the access and mobility node 3000 further comprises a second sending module 3006 configured to send a response to the session management node when the session management node is not the correct session management node for serving the PDU session. The response comprises second information indicating that the session management node is not the correct session management node for serving the PDU session.

Embodiments herein may provide many advantages, of which a non-exhaustive list of examples follows. In some embodiments herein, it proposes a new mechanism to secure the cleanup of hanging PDU session when a new PDU session with same PDU session ID is (to be) established. In some embodiments herein, it introduces a mechanism to secure that the AMF can successfully handle the traffic from the active PDU session and reject the traffic from the hanging PDU session. In some embodiments herein, it can resolve the problem observed from the live network. In some embodiments herein, it can improve the user experience. In some embodiments herein, it can improve KPI (Key Performance Indicator) in NG-RAN (due to decrease of the failure cause code: multiple-PDU-Session-ID-Instances). The embodiments herein are not limited to the features and advantages mentioned above. A person skilled in the art will recognize additional features and advantages upon reading the following detailed description.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first session management node, the second session management node, the data management node, the session management node, or the access and mobility node may not need a fixed processor or memory, any computing resource and storage resource may be arranged from the first session management node, the second session management node, the data management node, the session management node, or the access and mobility node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first session management node, comprising:
receiving a deregistration notification of a protocol data unit session of a user equipment from a data management node, wherein the deregistration notification comprises a deregistration reason indicating duplicated PDU session; and
releasing at least one resource corresponding to the PDU session.

2. The method according to claim 1, wherein the at least one resource comprises at least one of:
PDU session resource,
session management context,
SM policy association, or
N4 user plane resource.

3. The method according to claim 1, further comprising:
skipping sending a SM context status notify about a status of SM context related to the PDU session in the first session management node to an access and mobility node.

4. The method according to claim 3, wherein the access and mobility node comprises access and mobility function.

5. The method according to claim 1, further comprising:
sending a PDU session status notification about a status of PDU session resource related to the PDU session in the first session management node to a second session management node,
wherein the PDU session status notification indicates PDU session release due to duplicated PDU session.

6. The method according to claim 5, wherein the second session management node comprises at least one of an intermediate session management function or a visited session management function.

7. The method according to claim 1, further comprising:
sending a request for subscribing a notification of duplicated PDU session to the data management node,
wherein the deregistration notification is received from the data management node in response to the request.

8. The method according to claim 1, wherein the first session management node comprises a session management function or home SMF.

9. The method according to claim 1, wherein the data management node comprises a unified data management.

10. The method according to claim 1, wherein the deregistration notification comprises Nudm_UECM_DeregistrationNotification.

11. A method performed by a second session management node, comprising:
receiving a PDU session status notification about a status of PDU session resource related to a PDU session of a user equipment in a first session management node from the first session management node, wherein the PDU session status notification indicates PDU session release due to duplicated PDU session; and
releasing at least one resource corresponding to the PDU session.

12. The method according to claim 11, wherein the at least one resource comprises at least one of:
session management context,
SM policy association, or
N4 user plane resource.

13. The method according to claim 11, further comprising:
skipping sending a SM context status notify about a status of SM context related to the PDU session in the second session management node to an access and mobility node.

14. The method according to claim 13, wherein the access and mobility node comprises access and mobility function.

15. The method according to claim 11, wherein the second session management node comprises at least one of an intermediate session management function or a visited session management function.

16. The method according to claim 11, wherein the first session management node comprises a session management function or home SMF or an anchor SMF.

17. A method performed by a data management node, comprising:
receiving a registration request from a new session management node, wherein the registration request comprising an identifier of a PDU session of a user equipment;
determining whether an old session management node has registered it as a serving network function of a PDU session of the user equipment with the identifier of the PDU session on the data management node; and
when the old session management node has registered it as the serving network function of the PDU session of the user equipment with the identifier of the PDU session on the data management node, sending a deregistration notification of the PDU session comprising a deregistration reason indicating duplicated PDU session to the old session management node.

18. The method according to claim 17, wherein the registration request is without a registration reason.

19. The method according to claim 18, wherein the registration reason comprises session management context transfer.

20. The method according to claim 17, wherein the registration request comprises a registration reason indicating checking and reporting duplicated PDU session.

21-52. (canceled)
